(19) United States
(12) Patent Application Publication
(10) Pub. No.: US 2026/0035271 A1
(43) Pub. Date: Feb. 5, 2026

(54) Ammonium-Coordinated Exchanger (ACE) for Anion Contaminant Removal from Water

(71) Applicant: United States Department of Energy, Washington, DC (US)

(72) Inventors: McMahan Gray, Pittsburgh, PA (US); Walter Chris Wilfong, Canonsburg, PA (US); Fan Shi, Pittsburgh, PA (US); Qiuming Wang, Bridgeville, PA (US)

(21) Appl. No.: 18/788,427

(22) Filed: Jul. 30, 2024

(51) Int. Cl. C02F 1/42; B01J 41/04; B01J 41/13; B01J 49/57; C02F 101/22; C02F 101/36; C02F 103/18

(52) U.S. Cl. CPC C02F 1/42; B01J 41/04; B01J 41/13; B01J 49/57; C02F 2001/422; C02F 2101/22; C02F 2101/36; C02F 2103/18; C02F 2303/16

(57) ABSTRACT

Materials, methods of making, and methods of using an ammonium-coordinated exchanger (ACE) for anion contaminant removal from water. An ACE featuring: a polyamine network with amine groups, covalently attached to a substrate by a cross-linker; and an exchangeable anion coordinated to some of the amine groups. A method of making an ACE, featuring: generating a basic immobilized amine sorbent; and exposing the sorbent to an acid to form an ACE. An alternate method of making an ACE, featuring: forming an impregnation solution of a polyamine, cross-linkers, and anion exchange linkers, and combining the impregnation solution with a substrate to form an ACE. A method of using an ACE to capture an anionic species from a liquid source featuring: exposing the ACE to the liquid source and capturing the anionic species in the liquid source.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

One or more embodiments consistent with the present disclosure relate to capturing a variety of anions from wastewater using a coordinated exchange compound, and includes materials, methods of their preparation, and methods for using the compounds described in various applications.

### BACKGROUND

The US Resource Conservation and Recovery Act (RCRA) provided the US Environmental Protection Agency (EPA) with the authority to establish and enforce regulatory policies and toxicity limits regarding Arsenic (As), Cadmium (Cd), Chromium (Cr), Lead (Pb), Mercury (Hg), Selenium (Se), and other metals based on their adverse effects to human health upon exposure (RCRA species). Particularly challenging to capture are Se, As, and Cr, because they are commonly present in polyatomic oxyanion forms, which can vary in chemical structure due to oxidation-reduction reactions with different constituents in the water. For example, water soluble Se (in the VI and IV oxidation states) is expressed as selenate (SeO₄²⁻) and selenite (SeO₃²⁻) oxyanions; Cr, in its most water-soluble form, exists as a chromate oxyanion (CrO₄²⁻); and arsenic is also often in the arsenate (AsO₄³⁻, can be HAsO₄²⁻) and arsenite (AsO₃³⁻) forms. Additional anionic species, either regulated by the EPA or associated with an EPA health advisory, include nitrate/nitrite NO₃₋/NO_{2-,} sulfate (SO₄²⁻), and others.

Some sources of these contaminants may be natural, such as from fertilizer or agricultural runoff. Most other sources are industry-related and can include runoff from flue gas desulfurization (FGD) wastewater, acid mine drainage, and other fossil-fuel combustion or industrial-related processes. Regarding FGD wastewater discharge, the recently updated Steam Electric Reconsideration Rule by the EPA instituted limits for a series of contaminants, including As, NO₃₋/NO₂₋, bromide (Br), Hg, and Se. Although potentially less harmful than RCRA species, sulfate can cause problems, such as cracking of cement and brick mortar and corrosion of copper piping in home and industrial buildings. The well-known and widespread contamination of hazardous anionic species in our drinking water and other terrestrial water sources, either through natural processes or resulting from human activity, demands their remediation.

Additionally, radioactive pollutants in aqueous form also raise concerns about exposure levels, because fission products that have leaked into water systems can infiltrate the food chain and cause significant biological damage. For example, Tc-99, found at the Hanford Site in Washington, is a concerning radioactive ion due to its high environmental mobility under oxidizing states, in addition to its long half-life (2.1×10⁵ years). While the element Rhenium, Re is not radioactive waste per se, the non-radioactive perrhenate oxyanion (ReO₄₋) can be used as a test surrogate to test an adsorbent's adsorption performance of radioactive TcO₄ (the Tc-99 oxyanion), because the two ions are sufficiently similar to provide a basis for comparison.

Likewise, in addition to inorganic metal species, organic-based anionic pollutants, such as dyes (ex. FD&C 1 blue), herbicides/pesticides (for example, glyphosphate, an active ingredient in weed killer), and perfluoroalkyl polyfluoroalkyl (PFAS) substances originating from chemical production (for example, Teflon) and fire suppression foams, require remediation from water sources. The pervasiveness of inorganic and organic anions in wastewaters presents a unique challenge that may be addressed by sorbent technology, including the instant invention, which can be both available at low cost and highly selective towards these dangerous contaminants.

Current adsorption-based wastewater treatment options include carbon products acting as physisorbents, such as carbon nanotubes and activated carbon; minerals such as zeolites and clays acting via ion exchange, or acting as chemisorbents if functionalized; polymers, such as ion exchange resins and hydrogels; and non-carbon biological treatments. However, these prior art adsorption-based wastewater treatment options have drawbacks, including being costly and difficult to synthesize, having limited anion capacity, having low stability, and/or being highly condition-dependent for performance.

One or more advantages of embodiments of the invented ammonium-coordinated exchanger (ACE) sorbent over existing sorbent materials for wastewater treatment applications include high anionic contaminant removal performance via anion exchange mechanisms. Additionally, some embodiments of the invented ACE sorbent are capable of removing multiple types of anionic contaminants from wastewaters, including anionic metals, anionic dyes, and anionic radioactive pollutants, whereas existing silica-based sorbents for wastewater treatment primarily removed a single type of contaminant. Further, some embodiments of the invented ACE sorbent are quickly and easily prepared and scaled and can be used with existing reactor designs.

Embodiments of the invented ACE sorbent demonstrated a 5.9-10× and 2.4-8.4× higher maximum capacity for RCRA anionic metals than the flagship basic immobilized amine sorbent (BIAS) or next generation Multi-functional Sorbent Materials (MUST), respectively.

Embodiments of the invented ACE sorbent demonstrated superior selectivity towards removal of sulfate, nitrate, arsenate, selenate, and fluoride from commercial flue gas desulfurization (FGD) water compared to the prior state-of-the art BIAS and a commercial anion exchange resin, Purolite A600E/9149.

Embodiments of the invented ACE sorbent are regenerated with a NaCl solution.

A need exists in the art for a high-performance sorbent material that can remove multiple anionic contaminants from wastewaters, and a simple and cost-effective method of producing said sorbent that overcomes the disadvantages of the prior art. The novel method and principles of operation are further discussed in the following description.

### SUMMARY

Embodiments of the invention relate to materials, methods of making, and methods of using an ammonium-coordinated exchanger (ACE), featuring a porous silica support functionalized with a crosslinked, protonated polyamine/aminosilane polymer network, wherein the polymer network is coordinated to exchangeable anions via ammonium cation-anion interactions. The adsorption mechanism of ACE is primarily anion exchange, whereby anions coordinated to the sorbent are exchanged with anionic contaminants in wastewater.

Embodiments relate to a stable and regenerable ammonium-coordinated exchanger comprising a polyamine selected from the group consisting of polyethylenimine, ethylenediamine, diethylenetriamine, triethylenetetramine, tetraethylenepentamine, pentaethylenehexamine, hexaethyleneheptamine, 1,3-cyclohexanebis(methylamine), 4,4′-Methylenebis(cyclohexylamine), 3,3′-Methylenedianiline, 4,4′-Methylenedianiline, o-phenylenediamine, m-phenylenediamine, p-phenylenediamine, Tris(2-aminoethyl)amine, p-Xylylenediamine, 4-Chloro-o-phenylenediamine, N,N′-Dimethyl-1,3-propanediamine, N,N′-Diphenyl-p-phenylenediamine, N,N′-Diisopropyl-1,3-propanediamine, polyvinyl amine, poly(allylamine), poly(propyleneimine), and combinations thereof; a cross-linker selected from the group consisting of: tri-epoxide monomer, N—N-diglycidyl-4-15 glycidyloxyaniline (E3), epoxysilane, 2-(3,4-epoxycyclohexyl)ethyltrimethoxysilane (ECETMS), aminosilanes, 3-aminopropyltrimethoxysilane (APTMS), 3-aminopropyltriethoxysilane, N-(3-trimethoxysilyl)propyl)ethylenediamine (TMPED), N-(3-Trimethoxysilylpropyl) diethylenetriamine (TMPDET), chlorosilane, 3-chloropropyltriethoxysilane, 3-chloropropyltrimethoxysilane, and combinations thereof; a substrate selected from the group consisting of silica, bio-char, natural and synthetic zeolites, fly ash, alumina, activated carbon, metal surfaces comprising pendant —OH groups, porous polymers comprising pendant —OH groups, and combinations thereof; and an exchangeable anion is selected from the group consisting of: chloride, hydroxide, sulfate, hydrogen sulfate, nitrate, carbonate, and bicarbonate and combinations thereof.

Another embodiment relates to a method of making a stable and regenerable ammonium-coordinated exchanger. The method includes generating a basic immobilized amine sorbent (BIAS) and exposing the sorbent to an acid to form an ammonium-coordinated exchanger.

Yet another embodiment relates to an alternate method of making a stable and regenerable ammonium-coordinated exchanger. The method includes forming an impregnation solution comprising a polyamine, cross-linkers, and anion exchange linkers, wherein said polyamine comprises amine groups; and combining the impregnation solution with a substrate to form an ammonium-coordinated exchanger, wherein said ammonium coordinated exchanger comprises an exchangeable anion coordinated to at least some of said amine groups. The anion exchange linker is selected from the group consisting of \acute{α},\acute{α}-dichloro-p-xylene (DPX), carmustine, α,α-dichloro-m-xylene, 1,3-dichloropropanol, 1,3-dichlorobutane, 1,3-dichlorobenzene, 1,4-dichlorobenzene, and combinations thereof.

Still another embodiment relates to method of using an ammonium-coordinated exchanger to capture an anionic species from a liquid source comprising exposing the ammonium-coordinated exchanger to the liquid source, wherein the liquid source contains anionic species; and capturing at least some amount of the anionic species from the liquid source.

Embodiments include anion-adsorbing sites within low cost silica particles. Embodiments include regenerating an ammonium-coordinated exchanger.

The following U.S. patent applications are incorporated herein by reference in their entirety:
1. U.S. Patent Application No. 2010/0147770 A1 to Fryxell et al.
2. U.S. Patent Application No. 2014/0206532 A1 to Janke et al.
3. U.S. Patent Application No. 2011/0083684 A1 to Luan et al.
4. U.S. Patent Application No. 2013/0287662 A1 to Chuang.
5. U.S. Patent Application No. 2018/0100065 A1 to McMahan et al.
6. U.S. Patent Application No. 2023/0112681 A1 to McMahan et al.

The following articles are each incorporated herein by reference in their entirety:
1. Simandl, G. J., Geology and market-dependent significance of rare earth element resources. Mineralium Deposita, 2014. 49(8): p. 889-904.
2. Alonso, E., et al., Evaluating Rare Earth Element Availability: A Case with Revolutionary Demand from Clean Technologies. Environmental Science & Technology, 2012. 46(6): p. 3406-3414.
3. Noack, C. W., D. A. Dzombak, and A. K. Karamalidis, Rare Earth Element Distributions and Trends in Natural Waters with a Focus on Groundwater. Environmental Science & Technology, 2014. 48(8): p. 4317-4326.
4. Sun, X., H. Luo, and S. Dai, Mechanistic investigation of solvent extraction based on anion-functionalized ionic liquids for selective separation of rare-earth ions. Dalton Transactions, 2013. 42(23): p. 8270-8275.
5. Hatje, V., K. W. Bruland, and A. R. Flegal, Determination of rare earth elements after pre-concentration using NOBIAS-chelate PA-1® resin: Method development and application in the San Francisco Bay plume. Marine Chemistry, 2014. 160(0): p. 34-41.
6. Özerolu, C. and G. Keceli, Removal of strontium ions by a crosslinked copolymer containing methacrylic acid functional groups</p></p>. Journal of Radioanalytical and Nuclear Chemistry, 2006. 268(2): p. 211-219.
7. Gao, Y., et al., Adsorption of La3+ and Ce3+ by poly-γ-glutamic acid crosslinked with polyvinyl alcohol. Journal of Rare Earths, 2015. 33(8): p. 884-891.
8. Florek, J., et al., Selective recovery of rare earth elements using chelating ligands grafted on mesoporous surfaces. RSC Advances, 2015. 5(126): p. 103782-103789.
9. Florek, J., et al., Nanostructured hybrid materials for the selective recovery and enrichment of rare earth elements. Advanced Functional Materials, 2014. 24(18): p. 2668-2676.
10. Aguado, J., et al., Aqueous heavy metals removal by adsorption on amine-functionalized mesoporous silica. Journal of Hazardous Materials, 2009. 163(1): p. 213-221.
11. Ghoul, M., M. Bacquet, and M. Morcellet, Uptake of heavy metals from synthetic aqueous solutions using modified PEI-silica gels. Water Research, 2003. 37(4): p. 729-734.
12. Hong, G., et al., Nanofibrous polydopamine complex membranes for adsorption of Lanthanum (III) ions. Chemical Engineering Journal, 2014. 244(0): p. 307-316.
13. Song, Y., et al., Polyamidoxime/Poly (vinyl alcohol) Composite Chelating Fiber Prepared by Emulsion Spinning and Its Adsorption Properties for Metal Ions. Industrial & Engineering Chemistry Research, 2015. 54(49): p. 12367-12373.
14. Wilfong, W. C., B. W. Kail, and M. L. Gray, Rapid Screening of Immobilized Amine CO2 Sorbents for Steam Stability by Their Direct Contact with Liquid H2 O. ChemSusChem, 2015. 8(12): p. 2041-5.
15. Shannon, R. t., Revised effective ionic radil and systematic studies of interatomic distances in halides and chalcogenides. Acta Crystallographica Section A: Crystal Physics, Diffraction, Theoretical and General Crystallography, 1976. 32(5): p. 751-767.
16. Isenberg, M. and S. S. C. Chuang, The Nature of Adsorbed CO2 and Amine Sites on the Immobilized Amine Sorbents Regenerated by Industrial Boiler Steam. Industrial & Engineering Chemistry Research, 2013. 52(35): p. 12530-12539.
17. Silva M, E., S. Chakravartula S, and S. C. Chuang, Silica-Supported Amine Catalysts for Carbon-Carbon Addition Reactions. Topics in Catalysis, 2012. 55(7-10): p. 580-586.
18. Wilfong, W. C.; Kail, B. W.; Bank, T. L.; Howard, B. H.; Gray, M. L., Recovering Rare Earth Elements rom Aqueous Solution with Porous Amine-Epoxy Networks. ACS App. Mater. Interfaces 2017, 9, 18283-18294.
19. Wang, Q.: Wilfong, W. C.; Kail, B. W.; Yu, Y; Gray, M. L., Novel Polyethylenimine-Acrylamide/SiO 2 Hybrid Hydrogel Sorbent for Rare-Earth-Element Recycling From Aqueous Source. ACS Sustainable Chem. Eng.
20. Wang, Q., et al., Novel Polyethylenimine-Acrylamide/SiO₂ Hybrid Hydrogel Sorbent for Rare Earth Elements Recycling from Aqueous Sources. ACS Sustainable Chemistry & Engineering, 2017.
21. Silva, L. F. O., M. Wollenschlager, and M. L. S. Oliveira, A preliminary study of coal mining drainage and environmental health in the Santa Catarina region, Brazil. Environmental Geochemistry and Health, 2011. 33(1): p. 55-65.
22. Zhao, F., et al., The geochemistry of rare earth elements (REE) in acid mine drainage from the Sitai coal mine, Shanxi Province, North China International Journal of Coal Geology, 2007. 70(1-3): p. 184-192.
23. U.S. EPA (U.S. Environmental Protection Agency). 2016. Hydraulic Fracturing for Oil and Gas: Impacts from the Hydraulic Fracturing Water Cycle on Drinking Water Resources in the United States. Office of Research and Development, Washington, D.C. EPA/600/R-16/236Fa.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a flowchart for a method of making an ACE, in accordance with the features of the present invention;

FIG. 2 is a flowchart for an alternate method of making an ACE, in accordance with the features of the present invention;

FIG. 3 is a flowchart for a method of using an ACE to capture an anionic species from a liquid source, in accordance with the features of the present invention;

FIG. 4 is a graph showing chromate uptake by ACE particle and fiber sorbents, where silica particle and glass fiber supports were included as controls, in accordance with the features of the present invention;

FIG. 5A is a graph showing DRIFTS spectra of the ACE sorbent, DPX/PEI-1, generated using a single-step process as described herein, in accordance with the features of the present invention;

FIG. 5B is a graph showing DRIFTS spectra of the ACE sorbents, M043+HCl and M043+H₂SO₄, plus the chelation-based M043, the ACE sorbents generated using a two-step process as described herein, in accordance with the features of the present invention;

FIG. 6 is a diagram of an exemplary set-up for assessing sorbent stability via washing, where the same set-up was used for testing absorption of dissolved ions from flowing liquid environments, in accordance with the features of the present invention;

FIG. 7 is a graph showing the effect of E3/PEI ratio on the water stability/leach resistance of PEI/E3/Silica sorbent, in accordance with the features of the present invention;

FIG. 8 is a graph showing the relative maximum uptake of 6 anions by different sorbents (30-50 mg, dry basis) from separate, 5 mM concentrated solutions (50 mL), in accordance with the features of the present invention;

FIG. 9A is a graph showing the relative maximum uptake of 6 anions by M043+HCl and A600E/9149 (30-50 mg, dry basis) from a mixed, 5 mM concentrated solution with 0.83 mM each anion (50 mL), in accordance with the features of the present invention;

FIG. 9B is a graph showing the total uptake of anions and total charge by M043+HCl and A600E/9149 (30-50 mg, dry basis) from a mixed, 5 mM concentrated solution with 0.83 mM each anion (50 mL), in accordance with the features of the present invention;

FIG. 10A is a graph showing percent uptake with a treatment of 20 mL of 0.5 mL/min flowing D6 solution with 0.5 g of Ammonium-Coordinated Exchanger (ACE) in a fixed bed set-up, where M043 BIAS serves as a non-acid-washed control, in accordance with the features of the present invention;

FIG. 10B is a graph showing μmol of species captured with a treatment of 20 mL of 0.5 mL/min flowing D6 solution with 0.5 g of Ammonium-Coordinated Exchanger (ACE) in a fixed bed set-up, where standard M043 BIAS serves as a non-acid-washed control, in accordance with the features of the present invention;

FIG. 10C is a graph showing the amount of chloride plus sulfate anion released by M043+HCl and M043+H₂SO₄ for a treatment of 20 mL of 0.5 mL/min flowing D6 solution with 0.5 g of Ammonium-Coordinated Exchanger (ACE) in a fixed bed set-up, where M043 BIAS serves as a non-acid-washed control, and where the micromoles (μmols) of negative charge captured were calculated by multiplying the μmol of each anion in FIG. 10B by the negative charge of that anion, in accordance with the features of the present invention;

FIG. 11A is a graph showing the micromoles of anion captured or released from treatment of 20 mL of 0.5 mL/min flowing authentic acid mine drainage (local botanical garden) water with 0.5 g of M043+HCl ACE in a fixed bed set-up, highlighting the removal of oxyanionic sulfate (AMD, 453 ppm), where treatment of Milli-Q water (negligible sulfate) was performed as a control, in accordance with the features of the present invention;

FIG. 11B is a graph showing the micromoles of negative charge released into the solution as Cl⁻ or removed from the solution as SO₄²⁻ from treatment of 20 ml of 0.5 mL/min flowing authentic acid mine drainage (local botanical garden) water with 0.5 g of M043+HCl ACE in a fixed bed set-up, highlighting the removal of oxyanionic sulfate (AMD, 453 ppm), where treatment of Milli-Q water (negligible sulfate) was performed as a control, in accordance with the features of the present invention;

FIG. 12A is a graph showing the uptake of anions from treatment of 20 ml of 0.5 mL/min flowing D6 solution with 0.5 g M043 in a fixed bed set-up, in accordance with the features of the present invention;

FIG. 12B is a graph showing the uptake of anions from treatment of 20 mL of 0.5 mL/min flowing D6 solution with 0.5 g 181D in a fixed bed set-up, in accordance with the features of the present invention;

FIG. 13 is a diagram of an exemplary practical set-up for treating authentic wastewater, highlighting the exchange of equal charge from the ammonium-coordinated chloride anions and contaminant ions, where flow is shown as bottom-to-top, in accordance with the features of the present invention;

FIG. 14 is a graph showing the uptake of anions from treatment of 20 mL of 0.5 mL/min flowing authentic flue gas desulfurization water spiked with 150 ppm each of selenate and arsenate (Aquatech), using 0.5 g M043, M043+HCl, and M043+H₂SO₄ in a fixed bed set-up, in accordance with the features of the present invention;

FIG. 15 is a graph comparing the uptake of anions from the treatment of 20 mL of 0.5 mL/min flowing authentic flue gas desulfurization water spiked with 150 ppm each of selenate and arsenate (Aquatech), using 1.0 g (dry basis) of first generation M043; second generation metal-loaded M043+0.3Cu; M043+HCl; and a commercial Purolite anion exchange resin, A600E/9149, in a fixed bed set-up, where the resin, containing 42-45 wt % water, was dried prior to testing to give an equal comparison with the silica-based sorbents, in accordance with the features of the present invention;

FIG. 16 is a graph showing the uptake of anions from treatment of 20 mL of 0.5 mL/min flowing authentic flue gas desulfurization water spiked with 150 ppm each of selenate and arsenate and at different pH values (Aquatech), using 1.0 g (dry basis) of M043+HCl, in accordance with the features of the present invention;

FIG. 17 is a graph showing the uptake of anions from treatment of 20 mL of 0.5 mL/min flowing authentic flue gas desulfurization water from Longview Power Plant (coal-fired), spiked with 1,000 ppb selenate and pretreated with 0.1 wt % NaS relative to solution weight; where R.A. represents regulated anions regulated by the EPA for tap water plus bromide; and where about 32 mm bed lengths of as-is dry M043 (1.0 g), dry M043+HCl (1.5 g), and A600E/9149 (1.75 g wet, 1.0 g dry); and where the silica-based sorbents were rinsed with water in the column before testing to introduce mass transfer limitations similar to those of the resin, which is filled with about 43 wt % water, in accordance with the features of the present invention;

FIG. 18 is a graph showing results of a regeneration test for treating 20 mL of 0.5 mL/min flowing authentic, coal-fired Longview Power Plant flue gas desulfurization water, using 1.0 g (dry basis) of M043+HCl, in accordance with the features of the present invention;

FIG. 19A is a graph showing the uptake of FD&C blue 1 dye from fixed bed treatment of 20 mL 1 wt % FD&C blue 1 dye flowing at 0.5 mL/min over separate beds of 0.5 g M043+HCl and 0.88 g A600E/9149 (0.5 g dry basis); where the M043+HCl was pre-treated with Mill-Q water before dye uptake testing to introduce mass transfer limitations similar to those inherent of the 43 wt % wet resin; and where dye uptake was determined by constructing a calibration curve of visible light intensity (630 nm) versus dye concentration (0-50 ppm dye/H2O), then scanning the treated solutions, in accordance with the features of the present invention;

FIG. 19B is a photo comparison showing the uptake of FD&C blue 1 dye from fixed bed treatment of 20 mL 1 wt % FD&C blue 1 dye flowing at 0.5 mL/min over separate beds of 0.5 g M043+HCl and 0.88 g A600E/9149 (0.5 g dry basis); where the M043+HCl was pre-treated with Mill-Q water before dye uptake testing to introduce mass transfer limitations similar to those inherent of the 43 wt % wet resin; and where dye uptake was determined by constructing a calibration curve of visible light intensity (630 nm) versus dye concentration (0-50 ppm dye/H2O), then scanning the treated solutions, in accordance with the features of the present invention;

FIG. 20 a graph of water pH levels after treatment of 500 mL of pH 9.6 (NaOH/H2O) flowing at 0.5 mL/min by 0.5 g M043+HCl and 0.88 g A600E/9149 (0.5 g dry resin) in a fixed bed set-up, in accordance with the features of the present invention;

FIG. 21 is a graph comparing the anion uptake performance of unoptimized 1-step sorbent (DPX/PEI-1) relative to 2-step sorbent (M043+HCl) from the treatment of authentic flue gas desulfurization wastewater, in accordance with the features of the present invention;

FIG. 22A is a pictorial representation of ACE, in accordance with the features of the present invention;

FIG. 22B is a further pictorial representation of ACE, in accordance with the features of the present invention; and

FIG. 23 is a graph showing the concentrations of MPFOA in the fresh and M043+HCl ACE-treated solutions, in accordance with the features of the present invention.

### DETAILED DESCRIPTION

The foregoing summary, as well as the following detailed description of certain embodiments of the present invention, will be better understood when read in conjunction with the appended drawings. The composition of various sorbents described herein can be found in Table 1.

TABLE 1
Composition of different sorbents.

| | Organic | | | | |
|---|---|---|---|---|---|
| | loading | | Crosslinker 1 | Amine | Coordinated |
| Sorbent Name | (wt %) | Support | (wt %) | (wt %) | Ion (wt %) |
| 181D + HCl | 29 | silica | ECETMS/19.9 | PEI/9.1 | Cl^{—} |
| M043 + HCl | 31.2 | silica | E3/9.3 | PEI/21.8 | Cl^{—}/7.7 |
| M043 + H₂SO₄ | 35 | silica | E3/10.5 | PEI/24.5 | SO₄⁻²/10.2 |
| DPX/PEI-0.6 | 29.6 | silica | DPX/13.6 | PEI/16 | Cl^{—} |
| DPX/PEI-0.8 | 31.1 | silica | DPX/16.5 | PEI/14.6 | Cl^{—} |
| DPX/PEI-1.0 | 31.9 | silica | DPX/18.7 | PEI/13.2 | Cl^{—} |
| DPX/PEI-1.2 | 29.4 | silica | DPX18.5 | PEI/10.9 | Cl^{—} |
| DPX/PEI-1.4 | 23.7 | silica | DPX15.8 | PEI/7.9 | Cl^{—} |
| DPX/PEI-1.6 | 21.8 | silica | DPX/15.1 | PEI/6.7 | Cl^{—} |
| DPX/PEI-F-0.4 | 43.7 | glass | DPX/15.8 | PEI/27.9 | Cl^{—} |
| | | fiber mat | | | |
| DPX/PEI-F-0.6 | 52.3 | glass | DPX/24 | PEI/28.3 | Cl^{—} |
| | | fiber mat | | | |
| DPX/PEI-F-0.8 | 50.9 | glass | DPX/27 | PEI/23.9 | Cl^{—} |
| | | fiber mat | | | |
| DPX/PEI-F-1.0 | 50.6 | glass | DPX/29.6 | PEI/21 | Cl^{—} |
| | | fiber mat | | | |
| 20BCW + HCl | 20 | biochar | E3/6 | PEI/14 | Cl^{—} |
| M043 + 0.3Cu | | silica | E3/10.5 | PEI/24.5 | Cu²⁺ |
| | | | ECETMS/TMPED, | | |
| 14-34A | 30.3 | silica | 21.5/7.2 | PEI/11.9 | |
| 20BCW | 20 | biochar | E3/6 | PEI/14 | |
| M043; PEI/E3- | 35 | silica | E3/10.5 | PEI/24.5 | |
| 0.43/1 | | | | | |
| 181D | 29 | silica | ECETMS/19.9 | PEI/9.1 | |

The following detailed description should be read with reference to the drawings in which similar elements in different drawings are numbered the same. The drawings, which are not necessarily to scale, depict illustrative embodiments and are not intended to limit the scope of the invention.

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically to provide description of amorphous, organic-functionalized sorbent materials, methods of their preparation, and methods for using such materials.

As used herein, sorbent means a material that absorbs or adsorbs another substance, wherein a sorbent is not limited to a particular state of matter. Additionally, as used herein, “absorb” and “adsorb” are not limited to any particular type of chemical bonding, attachment, or attraction.

As used herein, cross-linker and crosslinker are equivalent and may be used interchangeably.

In any one or more embodiments described herein, the invented ammonium-coordinated exchanger (ACE) comprises a polyamine network attached to a substrate by a cross-linker either through covalent bonding or hydrogen bonding, wherein said polyamine comprises amine groups; and an exchangeable anion coordinated to at least some of said amine groups.

Embodiments/relate to materials, methods of making, and methods of using an ammonium-coordinated exchanger (ACE). Generally, embodiments of ACE feature a porous silica support functionalized with a crosslinked, protonated polyamine/aminosilane polymer network, wherein the polymer network is coordinated to exchangeable anions, primarily chloride (—Cl—), via ammonium cation-anion interactions.

The adsorption mechanism of ACE is primarily anion exchange, whereby CI-anions coordinated to the sorbent are exchanged with anionic metal/metalloid species, including isotopic radioactive species, and anionic organic contaminants. Secondarily, non-protonated amine groups —N, —NH, and —NH₂ retain the ability to capture cationic metals and other contaminants through chelation.

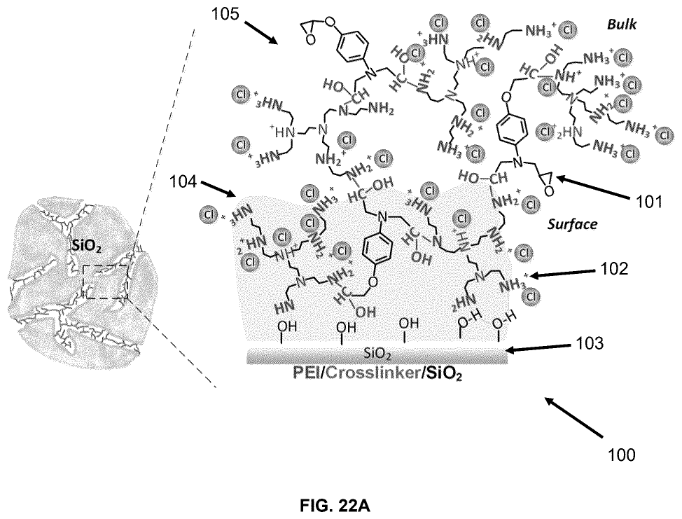

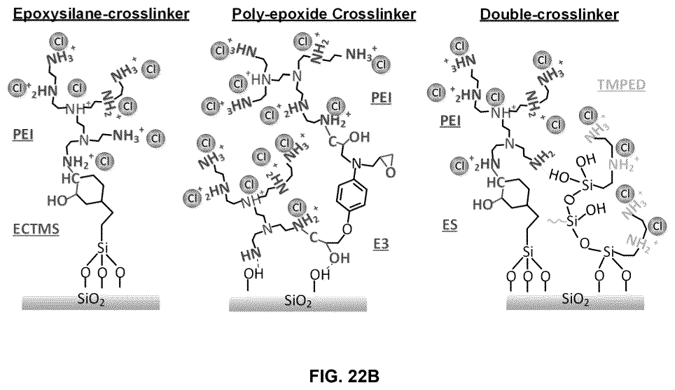

FIG. 22 shows a pictorial representation of an embodiment of the invented ACE 100. FIG. 22A shows the chemical structure of one exemplary ACE sorbent prepared from the tri-epoxide (E3) crosslinker 101 and polyethyleneimine 102 with a silica substrate 103, followed by protonation with HCl. In an embodiment, the ACE 100 comprises an interfacial substrate-polymer surface 104. In the embodiment shown in FIG. 22A, the interfacial silica-polymer surface layer is comprised of PEI and E3 that are both hydrogen-bonded to the silica surface and are further covalently bound together via C—N bonds formed by the amine (PEI)-epoxy (E3) crosslinking reaction. In an embodiment, the ACE 100 also comprises a bulk layer 105 that is comprised of crosslinked PEI-E3 species which are covalently linked to the interfacial PEI-E3 layer and inherently contain pendant —OH groups generated by the crosslinking reaction. In an embodiment, these-OH groups are also present in the interfacial layer, whereby in the interfacial and bulk layers the —OH can further stabilize the sorbent via hydrogen bonding with neighboring PEI and E3 molecules. In an embodiment, the —NH₃⁺, —NH₂⁺, and —NH⁺ groups within the interfacial and bulk layers were produced by the protonation of the —N, —NH, and —NH₂ groups of PEI with HCl during acid washing. FIG. 22B shows the interfacial structures of alternate exemplary ACE sorbents prepared from polyethylenimine and a single-crosslinker epoxysilane (ECETMS); and polyethylenimine and an ECETMS/aminosilane (TMPED) double crosslinker combination. In an embodiment, the epoxysilane and aminosilane linkers are anchored to silica via —Si—O—Si— covalent bonds formed by the reaction of the silane —OCH₃/—OCH₂CH₃ and silica Si—OH groups. In an embodiment, the epoxysilane attaches PEI to silica via C—N bonds formed from the epoxy (ECETMS)-amine (PEI) crosslinking reaction in both the single-crosslinker- and double crosslinker-based sorbents. In an embodiment, replacing a portion of the ECETMS linker with the TMPED linker in the double-crosslinker sorbent maintains the sorbent stability by TMPED attachment to silica while providing additional amine sites that are transformed into ammonium-chloride anion exchanger sites. In embodiments, both these single crosslinker and double crosslinker sorbents contain interfacial (silica/PEI/crosslinker interface) and bulk layers. In embodiments, within the bulk of the single-crosslinker sorbent, ECETMS crosslinks with itself via its silane groups to form a polymer cage, which then crosslinks PEI and traps the amine within the cage. In embodiments, within the bulk of the double-crosslinker sorbent, ECETMS-ECETMS, ECETMS-TMPED, and TMPED-TMPED crosslink via silane-silane and epoxy-amine reactions. In embodiments, this forms a cage, which then covalently reacts with PEI to trap the amine within. In embodiments, acid washing each sorbent produced the active —NH₃⁺, —NH₂⁺, and —NH⁺ sites. A person having ordinary skill in the art will readily recognize that the above-described structure and bonding of the exemplary embodiments of ACE shown in FIGS. 22A and 22B, though described using specific crosslinkers, substrates, and polyamines, are generally applicable in other embodiments described herein.

In any one or more embodiments described herein, the polyamine above is selected from the group consisting of: polyethylenimine, ethylenediamine, diethylenetriamine, triethylenetetramine, tetraethylenepentamine, pentaethylenehexamine, hexaethyleneheptamine, 1,3-cyclohexanebis(methylamine), 4,4′-Methylenebis(cyclohexylamine), 3,3′-Methylenedianiline, 4,4′-Methylenedianiline, o-phenylenediamine, m-phenylenediamine, p-phenylenediamine, Tris(2-aminoethyl)amine, p-Xylylenediamine, 4-Chloro-o-phenylenediamine, N,N′-Dimethyl-1,3-propanediamine, N,N′-Diphenyl-p-phenylenediamine, N,N′-Diisopropyl-1,3-propanediamine, polyvinyl amine, poly(allylamine), poly(propyleneimine), and combinations thereof. A person having ordinary skill in the art will readily understand that this list is exemplary and not meant to be limiting. In an embodiment, the polyamine comprises any polyamine and molecular weight thereof suitable for use in an ACE exchanger as described herein, i.e. suitable for crosslinking with the crosslinker or combination of crosslinkers and suitable for coordination to exchangeable anions described herein.

In an embodiment, the ACE comprises between approximately 5 and approximately 30 wt % polyamine.

In any one or more embodiments described herein, the cross-linker above is selected from the group consisting of: tri-epoxide monomer, N—N-diglycidyl-4-15 glycidyloxyaniline (E3), epoxysilane, 2-(3,4-epoxycyclohexyl)ethyltrimethoxysilane (ECETMS), aminosilanes, 3-aminopropyltrimethoxysilane (APTMS), 3-aminopropyltriethoxysilane, N-(3-trimethoxysilyl)propyl)ethylenediamine (TMPED), N-(3-Trimethoxysilylpropyl) diethylenetriamine (TMPDET), chlorosilane, 3-chloropropyltriethoxysilane, 3-chloropropyltrimethoxysilane, and combinations thereof. A person having ordinary skill in the art will readily understand that this list is exemplary and not meant to be limiting. In an embodiment, the crosslinker comprises any crosslinker and molecular weight thereof suitable for use in an ACE exchanger as described herein, i.e. suitable to crosslink the polyamine described above. In an embodiment, the ACE comprises more than one crosslinker.

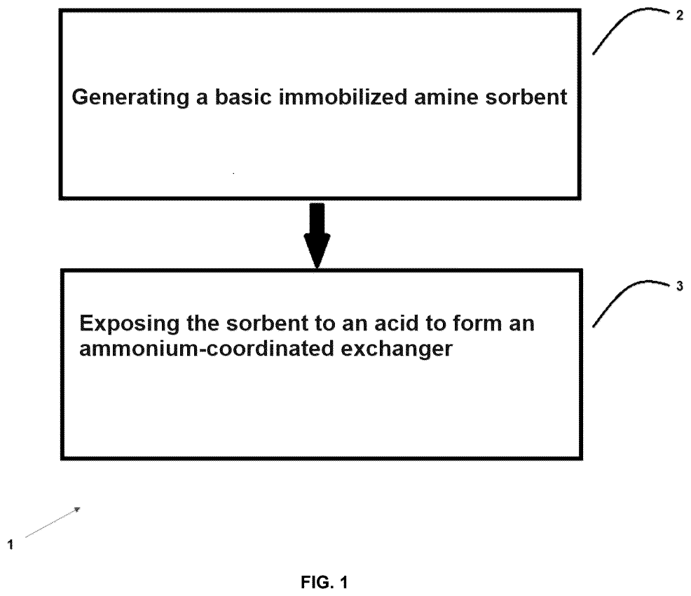

In any one or more embodiments described herein, multiple crosslinking reactions occur within the ACE, according to the different formulations. In embodiments, for a two-step acid-washed ACE (made using method 1 described below and shown in FIG. 1) comprising the tri-epoxide (E3) and PEI, E3 crosslinks PEI via C—N linkages formed between the epoxy group of E3 and the amine groups of PEI. In embodiments, for the two-step acid-washed ACE comprising silane-based crosslinkers, the following crosslinks are present: (i) ECETMS crosslinks with ECETMS via Si—O—Si linkages formed between each molecule's silane groups; (ii) TMPED crosslinks with TMPED via Si—O—Si linkages formed between each molecule's silane groups; (iii) ECETMS crosslinks with TMPED via Si—O—Si linkages formed between each molecule's silane groups and via C—N linkages formed between the epoxy group of ECETMS and the amine group of TMPED; (iv) ECETMS crosslinks with PEI via C—N linkages formed between the epoxy group of ECETMS and the —NH and —NH₂ groups of PEI. In embodiments, for a single-step comprised of the DPX and PEI, C—N crosslinks are formed between the reaction of the methyl chloride group (—CH₂—Cl) of DPX and the amine groups of PEI.

In an embodiment, the ACE comprises between approximately 5 wt % and approximately 30 wt % crosslinker. In an embodiment, the ACE comprises a crosslinker to polyamine ratio of approximately 0.4 to 1.5.

In any one or more embodiments described herein, the substrate is selected from the group consisting of: silica, bio-char, natural and synthetic zeolites, fly ash, alumina, activated carbon, metal surfaces comprising pendant —OH groups than can be functionalized, porous polymers comprising pendant —OH groups, and combinations thereof. A person having ordinary skill in the art will readily understand that this list is exemplary and not meant to be limiting. In an embodiment, the substrate comprises any substrate suitable for use in an ACE exchanger as described herein.

In any one or more embodiments described herein, the silica substrate serves as the porous support of the ACE. In embodiments, silica contains surface silanol groups (Si—OH), which serve to anchor the interfacial layer of the polymer network. In embodiments, for compositions containing ECETMS and TMPED, anchoring is accomplished through Si—O—Si linkages formed between the reaction of the silica-OH and the ECETMS and TMEPD silane groups (Si—O—CH₂—CH₃; Si—O—CH₃). In embodiments, for compositions containing tri-epoxide E3 and PEI, silica anchors the polymer network through hydrogen bonding of the Si—OH groups with the amine groups of PEI and epoxide groups of E3. Furthermore, in embodiments, ionic interactions between protonated amine groups of PEI And Deprotonated Silanol Groups in the Form of Si—O⁻ . . . ⁺³HN—⁺²HN-structures can anchor the polymer network to the substrate surface. In embodiments, the pores of silica serve to physically immobilize and trap the polymer network once the liquid amines and crosslinkers react within, whereby the formed network is too rigid to escape the mouth of the pore.

In an embodiment, the ACE comprises between approximately 40 and approximately 80 wt % substrate.

In any one or more embodiments described herein, the exchangeable anion is selected from the group consisting of chloride, hydroxide, sulfate, hydrogen sulfate, nitrate, carbonate, and bicarbonate, and combinations thereof. A person having ordinary skill in the art will readily understand that this list is exemplary and not meant to be limiting. In an embodiment, the exchangeable anion comprises any exchangeable anion for use in an ACE exchanger as described herein, i.e. suitable for coordinating to amine groups in the polyamine and suitable for exchange with anions from a liquid source.

In any one or more embodiments described herein, the anion is attached to the two-step, acid washed ACE via protonation of the —N, —NH, and —NH₂ groups of the non-washed crosslinked amine sorbent. In embodiments, HCl nearly entirely dissociates to H⁺ (H₃O⁺) and Cl ions in water. In embodiments, upon contact of the ions with the amine, H₃O⁺ donates H⁺ to the free electrons of the N atom of PEI amine groups to generate ammonium ions——NH⁺, —NH²⁺, and —NH³⁺. In embodiments, the Cl⁻ anions then coordinate to the ammonium ions to form —NH⁺ . . . Cl⁻, —NH²⁺ . . . . Cl⁻, and —NH³⁺ . . . . Cl⁻. In embodiments, the two-step acid washed ACE contains approximately 0.2 to 0.4 mol exchangeable Cl/mol N. In embodiments, the single-step ACE prepared from DPX and PEI inherently forms HCl as a byproduct of the DPX-PEI crosslinking reaction, whereby the produced HCl protonates the PEI amines which are coordinated with the Cl⁻ anions. In embodiments, these single-step ACE have approximately 0.05 to 0.2 mol exchangeable Cl/mol N.

A salient feature of this invention is the adsorption mechanism of ACE, which is primarily anion exchange, whereby exchangeable anions coordinated to a sorbent are exchanged with other anionic species, including arsenate, selenate, chromate, perrhenate, and others such as sulfate, nitrate, and fluoride. In embodiments, ACE demonstrated approximately a 5.9-10× and approximately a 2.4-8.4× higher maximum capacity for the RCRA anionic metals than current flagship basic immobilized amine sorbent (BIAS) or next generation Multi-functional Sorbent Materials (MUST), respectively. In an embodiment, ACE demonstrated superior selectivity towards removal of sulfate, nitrate, arsenate, selenate, and fluoride from commercial flue gas desulfurization (FGD) water compared to the BIAS and a commercial anion exchange resin, Purolite A600E/9149.

FIG. 1 depicts a flowchart for a method 1 of making an ACE, wherein the method is referred to as ‘two-step’ herein. The method 1 begins by generating a basic immobilized amine sorbent 2. In the first step of method 1 shown in FIG. 1, a basic immobilized amine sorbent (BIAS) is generated. BIAS comprises A stable and regenerable immobilized amine sorbent, characterized by covalently immobilized polyamine covalently attached to a silica surface by an epoxysilane and or an aminosilane. Specific embodiments of the various compositions of BIAS and methods of making same are described in in U.S. Patent Publication US20180100065A1 and U.S. Pat. No. 11,850,571B2 to Gray et al., the entirety of which is incorporated by reference herein.

Returning to FIG. 1, the method continues with exposing the sorbent to an acid 3 to form an ammonium-coordinated exchanger. In this exposing step 3, the anion is attached to the ACE via protonation of the —N, —NH, and —NH₂ groups of the non-washed crosslinked amine sorbent. In an embodiment, HCl nearly entirely dissociates to H⁺ (H₃O⁺) and Cl⁻ ions in water. In an embodiment, upon contact of the ions with the amine, H₃O⁺ donates H⁺ to the free electrons of the N atom of PEI amine groups to generate ammonium ions——NH⁺, —NH²⁺, and —NH³⁺. In an embodiment, the Cl⁻ anions then coordinate to the ammonium ions to form —NH⁺ . . . . Cl⁻, —NH²⁺ . . . . Cl⁻, and —NH³⁺ . . . . Cl⁻. In an embodiment, the acid is selected from the group consisting of hydrochloric acid, acetic acid, sulfuric acid, nitric acid, carbonic acid, and combinations thereof. A person having ordinary skill in the art will readily understand that this list is exemplary and not meant to be limiting. In an embodiment, the acid comprises any acid suitable to make an ACE as described herein. In an embodiment, ACE can be prepared by washing BIAS with an acid then washing with purified water or a highly concentrated salt solution.

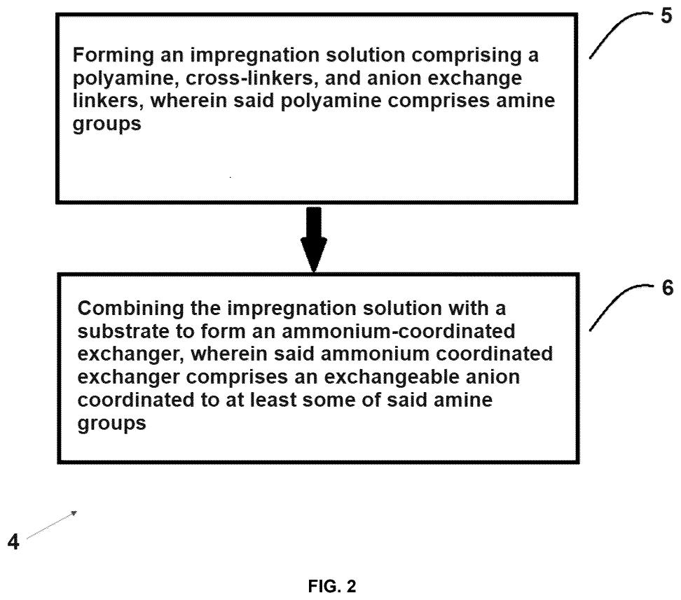

FIG. 2 depicts a flowchart for another method 4 of making ACE, wherein the method is referred to as ‘single-step’ herein. The method 4 begins with forming an impregnation solution 5 comprising a polyamine, cross-linkers, and anion exchange linkers, wherein said polyamine comprises amine groups. In an embodiment, forming an impregnation solution comprises mixing the polyamine, crosslinkers, and anion exchange linkers in warm MeOH or other organic solvent.

In the first step of method 4 shown in FIG. 2, an impregnation solution comprising a polyamine, crosslinker, and anion exchange linker is formed. In embodiments, the amount of different polyamines and crosslinkers is selected based on at least an amount of anionic species to be captured. A person having ordinary skill in the art will readily ascertain that said amount of different polyamines and cross-linkers can be any amount necessary for the ACE to capture some amount of anionic species.

In embodiments, the anion exchange linker is selected from the group consisting of: \acute{α},\tilde{α}-dichloro-p-xylene (DPX), carmustine, α,α-dichloro-m-xylene, 1,3-dichloropropanol, 1,3-dichlorobutane, 1,3-dichlorobenzene, 1,4-dichlorobenzene, and combinations thereof.

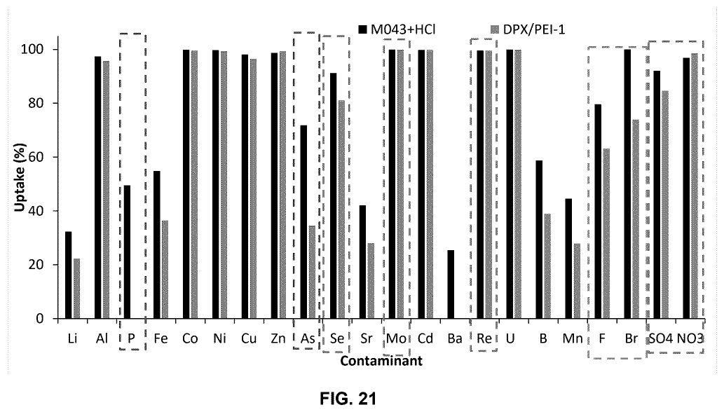

A salient feature of the method 4 shown in FIG. 2 is that it uses an anion exchange linker to coordinate the exchangeable anions and consequently does not require a separate acid washing step. In embodiments, ACE generated from this method utilizing an anion exchange linker demonstrated comparable anion uptake performance on authentic flue gas desulfurization wastewater to ACE generated using the method above utilizing acid washing (FIG. 21).

Returning to FIG. 2, the method continues with combining the impregnation solution with a substrate to form an ammonium-coordinated exchanger 6, wherein said ammonium coordinated exchanger comprises a polyamine network covalently attached to a substrate by a cross-linker, wherein said polyamine comprises amine groups; and an exchangeable anion coordinated to at least some of said amine groups.

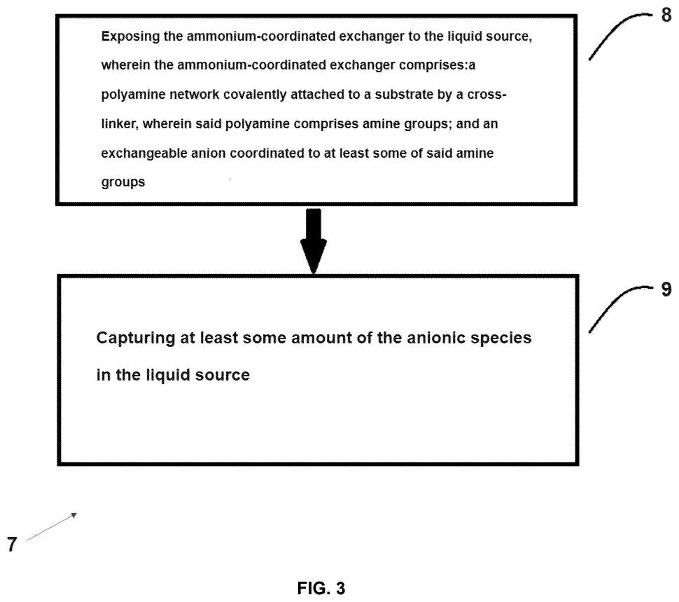

FIG. 3 depicts a flow chart for a method 7 of using ACE to capture an anionic species from a liquid source. The method 7 begins with exposing the ACE to the liquid source 8, wherein the ammonium-coordinated exchanger comprises a polyamine network covalently attached to a substrate by a cross-linker, wherein said polyamine comprises amine groups and an exchangeable anion coordinated to at least some of said amine groups. In embodiments, anion exchange sites are within the substrate. In embodiments, anion exchange sites are within low cost silica particles.

The method 7 continues with capturing at least some amount of the anionic species from the liquid source 9.

In embodiments, the at least one anionic species is selected from the group consisting of oxyanoinic, anionic metal, anionic metalloid, isotopic radioactive, anionic organic species, and combinations thereof. In embodiments, exemplary anions and oxyanions include sulfate, sulfite, hydrogen sulfate, nitrate, nitrite, phosphate, phosphite, chromate, dichromate, selenate, selenite, arsenate, arsenite, bromide, fluoride, carbonate, hydrogen carbonate, hydroxide, molybdate, and perrhenate. In embodiments, exemplary organic anions include FD&C No. 1 Brilliant Blue dye, FD&C Red 40 Allura red dye, and FD&C Green No. 3 Fast Green. In embodiments, ACE is exceptionally good at removing selenate from authentic wastewaters. In embodiments, ACE is good at removing perfluoroalkyl and polyfluoroalkyl substances (PFAS) from contaminated water sources.

A salient feature of the invention is that ACE is regenerable. In embodiments, adsorbed anionic species can be released, regenerating ACE. In embodiments, anions bind to ACE via charge-charge interactions, with minimal to no anion release when exposed to flowing water. In embodiments, regenerating ACE comprises exposing ACE with anionic species adsorbed thereto to NaCl solution releases said adsorbed anionic species and regenerates active exchange sites of ACE.

In embodiments, ACE is quickly and easily prepared and scaled and can be used with existing reactor designs.

### Examples

### Single-Step ACE Sorbent Preparation

An array of ACE comprised of organic species on silica (SiO₂) were prepared by first separately dissolving different amounts of a dichloro linker, α,α-dichloro-p-xyxlene (DPX), in MeOH warmed on a hotplate set at 50-60° C. Next, various amounts of polyethylenimine with a molecular weight of 800 g/mol (PEI) were dissolved in each of the warm DPX/MeOH solutions. The resulting impregnation solutions were then mixed with 6.0 g portions of silica (600 μm, Flo-Gard 214, PPG) in 250 mL round-bottom flasks. Each flask was placed in a rotary-evaporator and heated at 40-80° C. while rotating at 100 rpm and sequentially pulling a vacuum of 200 to 720 mm Hg for 60 min to evaporate methanol, followed by additional heating in either the rotary evaporator under slight vacuum or in the oven at 90° C. for 30-60 min. A total of six sorbents were prepared with the following mol Cl/mol N ratios—0.6, 0.8, 1.0, 1.2, 1.4, and 1.6. Subsequently, the dried sorbents were washed with water then MeOH to remove unbound organics and were then dried again. The sorbents were denoted as DPX-PEI-Y, where Y was the CI/N molar ratio.

Single-step ACE sorbents were also prepared with circular glass fiber sheets measuring about 2.75″ in diameter. Multiple solutions were prepared by dissolving 20 wt % of PEI plus DPX at CI/N ratios of 0.4, 0.6, 0.8, and 1.0 into a warm solvent mixture of 8 g MeOH and 10 g toluene. A 2-2.1 g amount of each solution was dripped onto separate 0.29 g fiber sheets, then the sheets were heated in an oven at 90° C. for 90 min to evaporate solvent and complete the crosslinking rection. Like the particles, the fibers were washed with water and MeOH, then dried.

### Anion Uptake Testing

Uptake testing of anionic chromate, CrO₄²⁻, by ACE fibers and particles was performed using a batch and flow set-up, respectively. Batch testing was conducted by placing about 0.2-0.3 g ACE fibers cut into ¼×¼″ pieces into 40 ppm chromate solution (Na₂CrO₄; solution/fiber ratio of 40/1) and soaking under gentle agitation for 1 hour. Flow testing was conducted by passing 20 mL of 102 ppm chromate solution at 0.5 mL/min over 0.5 g ACE particles. The concentrations of fresh and treated chromate solution were determined from a UV-Vis calibration curve, which plotted the 372 nm light intensity versus chromate concentration.

### Results

Table 2 shows the DPX/PEI organic loading on each of the particle and fiber sorbents.

TABLE 21
Organic loading of single-step particle and fiber ACE sorbents.

| | Cl/N | Organic loading, | OCR* |
|---|---|---|---|
| Sorbent name | ratio | washed (wt %) | (%) |
| DPX/PEI-0.6 | 0.6 | 29.6 | 81.2 |
| DPX/PEI-0.8 | 0.8 | 31.1 | 111.8 |
| DPX/PEI-1.0 | 1.0 | 31.9 | 99.6 |
| DPX/PEI-1.2 | 1.2 | 29.4 | 86.2 |
| DPX/PEI-1.4 | 1.4 | 23.7 | 90.4 |
| DPX/PEI-1.6 | 1.6 | 21.8 | 80.2 |
| DPX/PEI-F-0.4 | 0.4 | 43.7 | |
| DPX/PEI-F-0.6 | 0.6 | 52.3 | |
| DPX/PEI-F-0.8 | 0.8 | 50.9 | |
| DPX/PEI-F-1.0 | 1.0 | 50.6 | |

*Organic content retained after water and MeOH washing: OCR = wt % Organic_{Washed}/wt % Organic_{Fresh} × 100%.

Organic loadings varied between 20 and 32 wt % for the washed particle sorbents and between 43-53 wt % for the fiber sorbents. OCR values showed that the fresh (unwashed) particles were entirely stable at the CI/N ratios of 0.8 and 1.0.

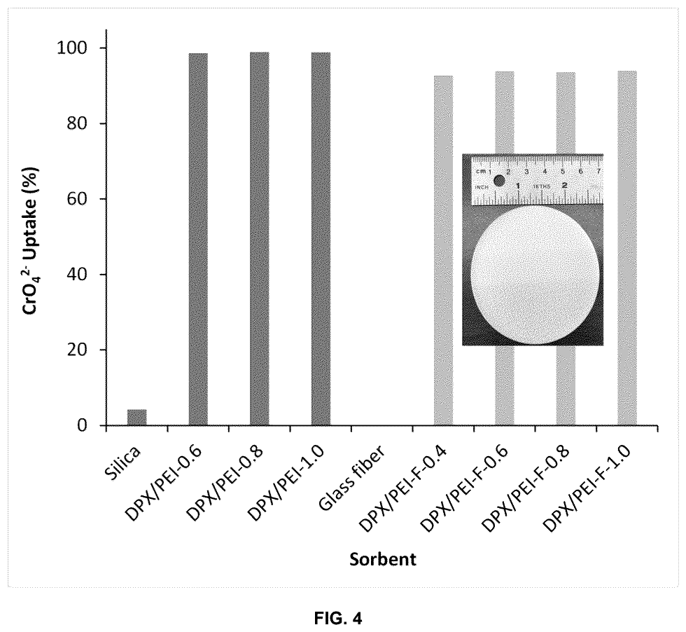

The uptake results in FIG. 4 show that both the ACE particles and fibers captured nearly all the anionic chromate from water. Contrastingly, the silica and fiber supports captured nearly no chromate. This confirms that the ammonium-coordinated exchanger sites created by the DPX-PEI crosslinking reaction were responsible for chromate adsorption.

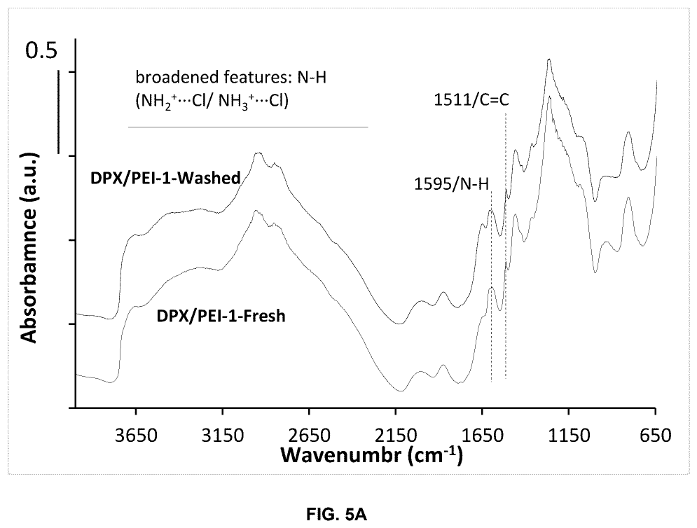

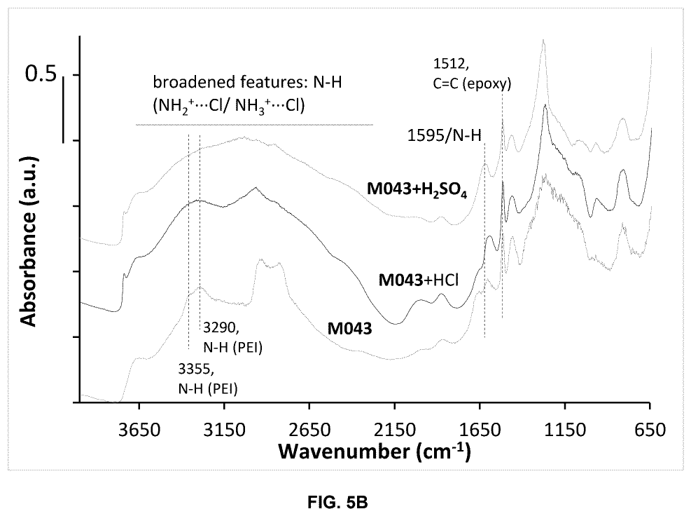

The DRIFTS spectra in FIG. 5B confirm that after acid washing with HCl, primary and secondary amine sites of PEI were transformed into protonated amines (ammonium ions), evidenced by the lack of the N—H doublet at 3355 and 3290 cm⁻¹ and the new broad IR features between 3650 and 2150 cm⁻¹ from N—H stretching of hydrogen-bonded ammonium ions (NH₂⁺/NH₃⁺). Negatively charged chloride anions were necessarily coordinated to the positively charged ammonium groups to balance the charge. The spectra in the top of FIG. 5A show the same broad IR features for the single-step sorbent as for the two-step sorbents, signifying the protonated amine sites of PEI. These sites were generated by the crosslinking rection of DPX with PEI, which produced HCl. The HCl then protonated the amines, with Cl necessarily coordinated to the newly formed ammonium ions. The DPX/PEI-1 sorbent showed similarly strong IR features of PEI (N—H, 1595 cm⁻¹), protonated PEI, and DPX (C═C, 1511 cm⁻¹) before and after washing as little unbound species were removed.

### Perfluoroalkyl/Polyfluoroalkyl Substance (PFAS) Testing

Contamination of water systems with perfluoroalkyl and polyfluoroalkyl substances (PFAS) is a growing hazard. The polymer and precursor chemicals can originate from many sources, such as fire suppression foam, food packaging, and some non-stick cookware. ACE was used to remove PFAS from water. A 20 mL portion of 38 ppm methylperfluorooctanoate (MPFOA) solution was flowed at 0.5 mL/min over 0.5 g of M043+HCl particles. Ion chromatography (IC) was used to determine the MPFOA concentrations in the fresh and treated solution.

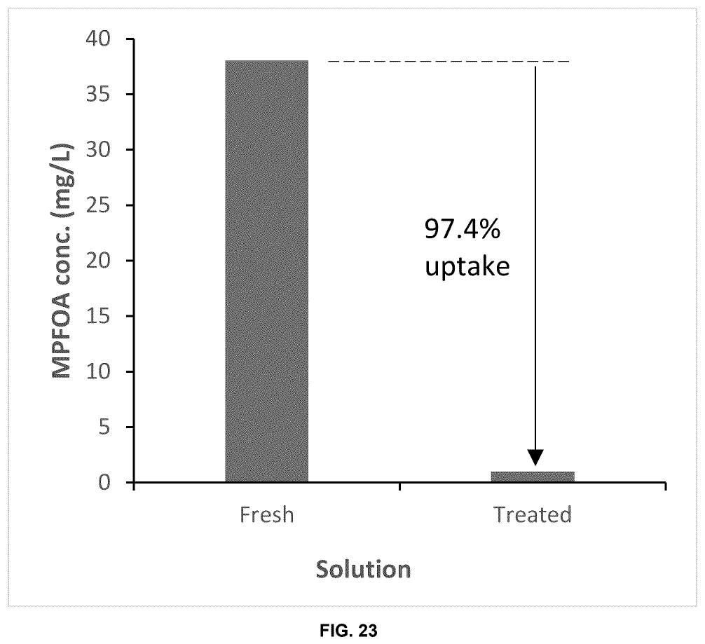

FIG. 23 shows the concentrations of MPFOA in the fresh and M043+HCl ACE-treated solutions. M043+HCl removed at least 97.4% of the MPFOA, reducing the MPFOA concentration to below the 1 mg/L calibrated IC detection limit. Thes results confirm that ACE can remove PFAS from contaminated water sources.

### Two-Step Sorbent Preparation

An array of basic immobilized amine sorbents (BIAS) comprised of 40 wt % organic species on silica (SiO₂) were prepared first by dissolving polyethylenimine with a molecular weight of 800 g/mol (PEI) and crosslinkers in MeOH. The resulting impregnation solutions were then mixed with 6.0 g of silica (500 μm, PQ CS 2129, PQ Corp.) in a 250 mL round-bottom flask, which was placed in a rotary-evaporator and heated at 40-80° C. while rotating at 100 rpm and sequentially pulling a vacuum of 200 to 720 mm Hg for 60 min to evaporate methanol, followed by additional heating in either the rotary evaporator under slight vacuum or in the oven at 90° C. for 30-60 min. The crosslinkers used were the following: (i) tri-epoxide monomer, N—N-diglycidyl-4-15 glycidyloxyaniline (E3), (ii) epoxysilane, 2-(3,4-epoxycyclohexyl)ethyltrimethoxysilane (ECETMS) and (iii) aminosilanes, such as 3-aminopropyltrimethoxysilane (APTMS), N-(3-trimethoxysilyl)N-(3-propyl)ethylenediamine (TMPED), and Trimethoxysilylpropyl) diethylenetriamine (TMPDET). One group of formulations containing different ratios of E3/PEI were comprised of 6 g silica, 1.6-3.5 g of PEI, and 0.5-2.4 g of N—N-diglycidyl-4-glycidyloxyaniline tri-epoxide monomer (E3). The wt % of E3 was 4.6-24 wt % and PEI was 16-35 wt %, giving E3/PEI weight ratios between 0.13 and 1.50. One additional sorbent prepared with water-washed biochar and containing 20 wt % of a PEI/E3-0.43/1 was labeled 20BCW. Another sorbent, previously known as 181D (flagship BIAS), contained the epoxy silane and was composed of 13.1 wt % PEI₈₀₀, 28.6 wt % ECETMS, and 58.3 wt % silica. An additional sorbent, previously known as 14-34A, from the Multi-functional Sorbent Technology (MUST) portfolio contained 11.9 wt % PEI₈₀₀, 7.2 wt % TMPED, 21.5 wt % ECETMS, and 59.3 wt % silica.

After screening for the most stable silica-based sorbent formulations through accelerated water testing described below, additional batches of fresh silica- and biochar-based sorbents were washed in a batch set-up by soaking 5.0 g sorbent in multiple batches of fresh Ultrapure Milli-Q water under gentle tumbling on a bottle roller until the leached PEI concentration in water was less than 50 ppm-about 1,500 ml water for 5.0 g dry sorbent. After H₂O washing, the sorbent was filtered then treated in a batch set-up with either 0.1M HCl (PH˜1.1), 0.1 M H₂SO₄ (PH˜1.7), or 5 wt % acetic acid (PH˜2.4) by soaking 10 g portions of washed sorbent (˜5 g dry sorbent basis) in 1 to 3, 500 mL acid portions until the pH of the treated solution was nearly equal to that of the fresh acid solution. After acid treatment, the sorbent was filtered and washed with copious amounts of ultrapure water until the pH of the liquid was 3 to 4, and then was dried at 60° C. overnight. Treating the washed sorbent with low pH acid caused protonation of the amine groups to generate primary, secondary, and possibly tertiary ammonium ions coordinated to the acids Cl, SO₄²⁻, and CH₃COO⁻ counter-anions. These counter-anions represent the exchangeable groups that are displaced by toxic anion species, which become adsorbed through ionic interactions with the ammonium ions.

### Characterization:

### Sorbent H₂O Stability Testing

Initial screening of the sorbents for their stability in a flowing liquid environment was accomplished using our published accelerated H₂O method, which involved contacting 0.5 g of sorbent with 0.5 mL/min of flowing H₂O for 20 min. The washed sorbent materials were dried at 70° C. in a drying oven and then subjected to thermogravimetric analysis (TGA) to determine the percentage of the organic content that was retained (OCR). The organic content of the sorbents was verified with a thermogravimetric analyzer (TGA) by pretreating the fresh and water-treated sorbents at 105° C. in N₂ flow for 2 hours, and then decomposing the pretreated sorbents at 800° C. Furthermore, more stable sorbents were further evaluated for their stability by washing them with water then analyzing the solution for amine content, using our previously-published UV-Vis/Cu²⁺ aqueous amine quantification method. Briefly, amine wash solution samples were diluted with ultrapure water; 2 mL wash solution was mixed with 2 mL 500 ppm Cu²⁺ solution; then the mixture was scanned in a GENESYS IS 10 (Thermo Scientific) ultraviolet-visible spectrometer to determine aqueous amine concentration.

### Infrared Spectroscopy

Diffuse Reflectance Infrared Fourier Transform Spectroscopy (DRIFTS) analysis was performed on the fresh and acid treat sorbents to assess their chemical structure resulting from interaction with acid. About 10-20 mg of sorbent were loaded into the sample cup of a DRIFTS SMART accessory set inside a Nicolet 8700 infrared spectrometer (Thermo Scientific). IR single beam spectra of pretreated sorbents (120° C., N2, 30 min) were obtained at 50° C.

### Scanning Electron Microscopy (SEM) and Energy Dispersive X-Ray Spectroscopy (EDX)

SEM images of fresh and ammonium-coordinate exchanger (ACE) sorbents were obtained with an FEI Company Quanta 600 field emission scanning electron microscope equipped with secondary and backscatter electron detectors. EDS elemental assessment of N, Cl, and S of the sorbents was accomplished with an Oxford Inca Energy 350 X-act energy dispersive x-ray analyzer.

### Carbon-Hydrogen-Nitrogen-Sulfur Analysis

Carbon-hydrogen-nitrogen-sulfur (CHNS) analysis of the original and acid washed sorbents was performed with a Perkin Elmer II Series CHNS elemental analyzer to determine the N and S content of the materials. Generally, solid sorbents were combusted in an oxygen rich environment, where the generated gases were analyzed with a frontal chromatography unit.

### Adsorption Studies

Sorbent uptake tests were conducted by one of two methods. Batch mode, relative maximum anion uptake tests were performed by soaking 50 g of novel ACE, 1 ^{st} generation crosslinked BIAS (not acid treated), Cu-loaded BIAS (MUST, 2^{nd} generation), plus commercial activated carbon and anion exchange resin (Purolite) for 24 hours in 50 mL of concentrated anion solution. The separate treated solutions contained either 5 mM of single-anion SO₄²⁻ (Na₂SO₄), HPO₄²⁻ (Na₃PO₄), NO₃⁻ (NaNO₃), NO₂⁻ (NaNO₂), CrO₄²⁻ (NaCrO₄), HASO₄²⁻ (Na₂HAsO₄*7 H₂O), and SeO₄²⁻ (sodium selenate) or 0.83 mM of each anion in a 5 mM mixed-anion solution. Following metal uptake, the treated solutions were decanted from the sorbents and analyzed for aqueous metal content.

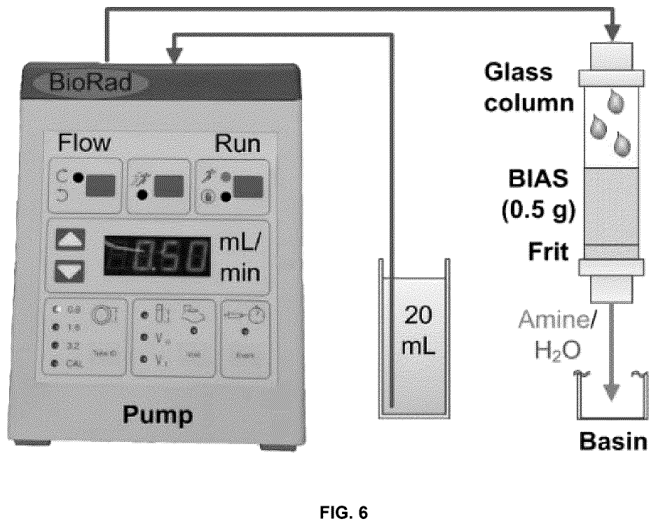

For the flow treatment tests performed at room temperature, 18-22° C., 20 mL of different metal-contaminated solutions were flowed at 0.5 mL/min over separate 0.5-1.5 g sorbent beds for 40 min (FIG. 6) Solutions tested include the following: (i) “dirty 6” (D6) with 10-35 ppm each of Hg²⁺ (HgCl₂), Cd²⁺ (CdCl₂), Pb²⁺ (PbCl₂), CrO₄²⁻, HAsO₄²⁻/AsO₄³⁻ (arsenate, presumably as HASO₄²⁻ form), and SeO₄²⁻; (ii) 74 ppm NO₃⁻; (iii) 75 ppm NO₂⁻; (iv) 64 ppm NO₃⁻, 40 ppm NO₂⁻; authentic flue gas desulfurization (FGD) water supplied by Longview coal power plant, both (v) as-received and (vi) pretreated (Se-spiked (as selenate), NaS pretreated); (vii) authentic conditioned FGD supplied by Aquatech (180 ppm As-spiked (as arsenate) and 203 ppm Cr-spiked (as chromate)); and (viii) authentic acid mine drainage supplied by the Pittsburgh Botanic Garden. The composition for some of the more complex solutions is shown in TABLE 3.

Concentrations of target metals and ions in all solutions were measured using a Nexion 300D ICP-MS (Perkin Elmer). Data were collected in kinetic energy discrimination (KED) mode using 2-4 ml/min He as the collision gas. Indium was used as an internal standard. A calibration curve was constructed, relating known concentrations of different ions in deionized (DI) H₂O to the ICP-MS response intensity. This curve was used to calculate the ions concentration in our solutions. Hg content was determined by CVAAS cold vapor atomic absorption spectroscopy. The specific anion content of chloride, fluoride, bromide, sulfate, nitrate, and nitrite were determined by ion chromatography (IC).

TABLE 3
Composition of complex wastewaters treated by ammonium-coordinated exchanger
(ACE) anion exchange sorbents. BDL means below detection limit; REE (rare
earth elements) sums concentrations for lanthanum through lutetium.

| | | Longview FGD | Aquatech FGD | | |
|---|---|---|---|---|---|
| | Longview | (aged, Se^{—} | (As^{—}, Cr^{—} | | |
| Analyte | FGD (Fresh) | spiked) | spiked) | AMD | D6 |
| pH | 6.9 | 7 | 6.3 | 3.4 | 6.2 |
| Cations - | | | | | |
| ug/L | | | | | |
| Be | | 0.07 | | | |
| Si | | 7,410 | | | |
| Ti | | 171 | | | |
| Sb | | 4.57 | | | |
| B | 355,417 | 227,100 | 111,917 | 505 | |
| Na | 1,222,437 | 1,049,000 | 40,208 | 3,280 | 59,615 |
| Mg | 3,844,929 | 2,771,000 | 586,409 | 12,993 | |
| Al | 226 | 28 | 30 | 5,546 | |
| K | 111,432 | 454,700 | 8,932 | 264 | |
| Ca | 1,021,000 | 850,276 | 2,333,000 | 52,020 | |
| Sc | 3.31 | | 1.17 | 1.16 | |
| Cr | 1.74 | 2.56 | 203.41 | 1.17 | 23,719 |
| Mn | 44,590 | 17,115 | 523 | 143 | |
| Fe | 34 | 51 | 92 | 85 | |
| Co | 231 | 0.63 | 1.86 | 20 | |
| Ni | 906 | 86 | 112 | 55 | |
| Cu | 7.84 | 47 | 10 | 6.93 | |
| Zn | 638 | | 1,077 | 69 | |
| As | BDL | 8.27 | 182 | BDL | 18,340 |
| Se | 521 | 1,110 | 54 | 6.97 | 23,840 |
| Sr | 6,040 | 5,348 | 12,204 | 686 | |
| Y | BDL | 205 | 0.66 | 8.50 | |
| Mo | 174 | | 7.82 | 0.04 | |
| Cd | 23 | 0.29 | 49 | 0.56 | 12,118 |
| Ba | 53 | 3.26 | 289 | 2.86 | |
| REE (La—Lu) | 1.38 | | 0.73 | 58 | |
| Re | 11 | | 8.07 | BDL | |
| Pb | 0.03 | 0.07 | 0.13 | 0.16 | 22,464 |
| Th | 0.02 | | BDL | 0.08 | |
| U | 123 | | 33 | 0.27 | |
| Hg | 0.0025 | | 1.38 | BDL | 34,700 |
| Anions - mg/L | 158 | 212,700 | | | |
| P (by ICP- | | | | | |
| MS, OES) | | | | | |
| F^{—} | 85 | 6.60 | 5.32 | BDL | |
| Cl^{—} | 9,843 | 7,379 | 4,279 | 2.35 | |
| NO₂^{—} | BDL | BDL | BDL | BDL | |
| SO₄^{2—} | 4,635 | 3,926 | 1,263 | 202 | |
| Br^{—} | | 137 | | | |
| NO₃^{—} | 158 | 2.65 | 108 | BDL | |

### Results and Discussion

### Sorbent Characterization and Stability

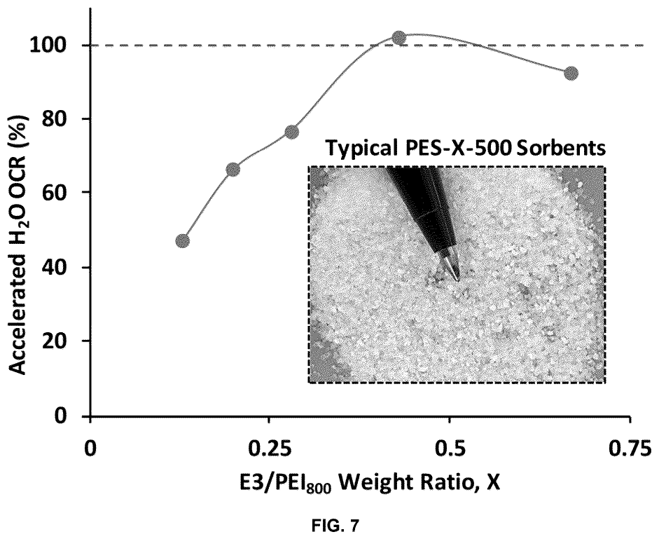

FIG. 7 shows that beginning at an E3/PEI ratio of 0.43, sorbents exhibited slightly maximum retention of the organic species (OCR, organic content retained=wt % Organic_{washed}/wt % Organic_{fresh}×100%). Alternative to TGA decomposition of the washed sorbents to determine organic content, UV-Vis analysis of the wash water revealed about 91% of the PEI was retained, highlighting that the apparent increase in OCR likely resulted from water reacting with the epoxide to form pendant —OH groups. Sorbents prepared with an E3/PEI ratio greater than or equal to 0.43 were further acid treated to give the Ammonium-Coordinated Exchanger (ACE).

The DRIFTS spectra in FIG. 5B confirm that after acid washing with HCl, primary and secondary amine sites of PEI were transformed into protonated amines (ammonium ions), evidenced by the lack of the N—H doublet at 3355 and 3290 cm⁻¹ and the new broad IR features between 3650 and 2150 cm⁻¹ from N—H stretching of hydrogen-bonded ammonium ions (NH₂⁺/NH₃⁺). Negatively charged chloride anions were necessarily coordinated to the positively charged ammonium groups to balance the charge.

CHNS and EDS results presented in Table 4 highlight the amount of immobilized N, Cl, and S on the sorbents after excessive washing to remove non-immobilized or unreacted species. The presence of 7.7 wt % Cl⁻ confirms the retention of the anion, necessarily coordinated to the NH₃⁺, NH₂⁺ and potentially NH⁺ (tertiary ammonium ion) species. This Cl⁻¹ serves as the anion exchange group to be displaced by the oxyanionic contaminant species.

TABLE 4
Elemental analysis of HCl and H₂SO₄ treated Ammonium-Coordinated Exchanger (ACE) sorbents,
M043 + HCl and M043 + H₂SO₄, respectively. Unwashed M043 was included as a control.
Analyses of the sorbents were taken after the excessive washing to remove nearly all unreacted acid.

| | | | | | Ion- |
|---|---|---|---|---|---|
| | | | | | exchangeable |
| | | wt % Element | | | charge |
| | N | Cl | S | Molar conc. | mmol neg. |
| Sorbent | (CHNS/EDS) | (CHNS/EDS) | (CHNS/EDS) | mmol Cl, S/g-sorb. | charge |
| M043 | 8.4/8.4 | | | | |
| M043 + HCl | 6.9/7.5 | 7.7 | | 2.2 | 2.2, Cl^{—} |
| M043 + H₂SO₄ | 6.0/7.3 | | 3.4 | 1.1 | 1.1 (all HSO₄⁻); |
| | | | | | 2.2 (all SO₄²⁻) |

Similarly, the 3.4 wt % S confirms the presence of a coordinated oxyanionic sulfur species. Because the dissociation of H₂SO₄ into water gives H₃O⁺ and HSO₄⁻ (pKa˜−2) plus SO₄²⁻ (pKa˜1.99), the former bisulfate species is the more likely counter than the latter sulfate. These results along with those form the DRIFTS confirm the stable chemical immobilization of chloride and sulfate or hydrogen sulfate groups to the sorbent through anion-ammonium cation ionic interactions. The strong acidity of HCl and H₂SO₄show they dissociate easily due weak bonding of the conjugate base chloride and sulfate/bisulfate anions to hydrogen. The weaker conjugate bases, Cl⁻ and HSO₄⁻, coordinated to the ammonium ions should easily be displaced by stronger conjugate bases, like SO₄²⁻, NO₃⁻ (HNO₃ to NO₃⁻, pKa˜−1.37), SeO₄²⁻ (H₂SeO₄ to SeO₄²⁻, pKa˜1.9), AsO₄²⁻, CrO₄²⁻, F⁻, and other anionic species.

### Metal Uptake Performance and Mechanism

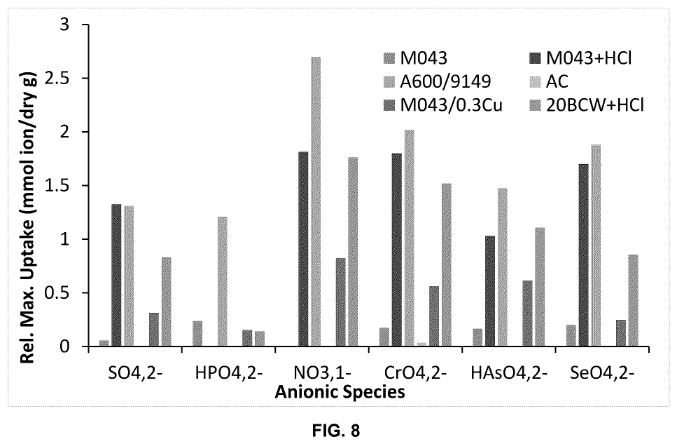

FIG. 8 compares the relative maximum uptake capacities of sulfate, phosphate, nitrate, chromate, arsenate, and selenate for the ACE, M043+HCl; BIAS, M043; 0.3 wt % copper-loaded M043, M043/0.3Cu, from the recent patent-pending Multi-functional Sorbent Technology (MUST) portfolio; HCl washed, 20 wt % PEI/E3/biochar (additional ACE formulation) labeled as 20BCW+HCl; commercial activated carbon, AC (Calgon); and commercial anion exchange resin designed for nitrate and sulfate removal, A600E/9149 (Purolite). M043+HCl and 20BCW+HCl ACE sorbents showed superior capacity towards all anions relative to M043, M043/0.3Cu, and activated carbon.

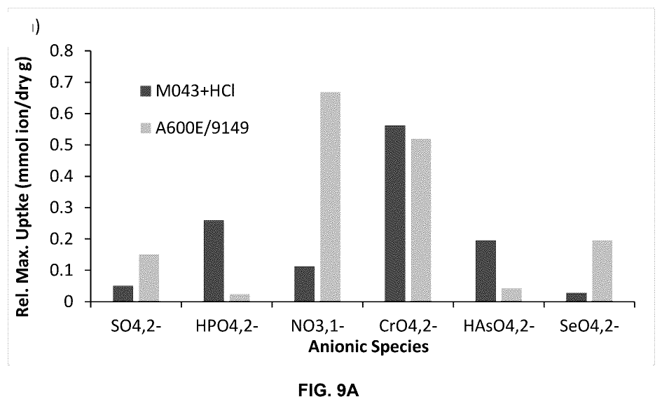

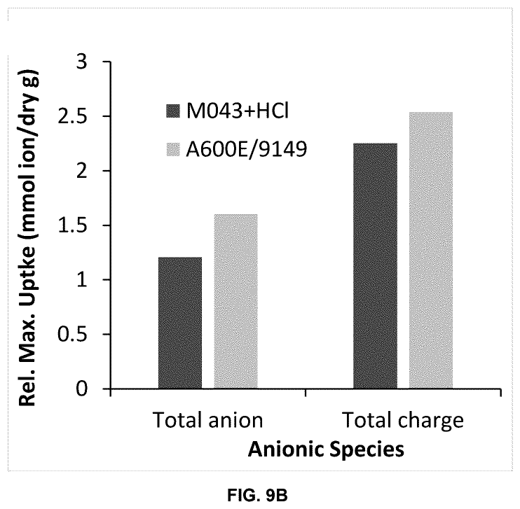

These ACE further demonstrated nearly equal capacity towards sulfate, chromate, and selenate. Although phosphate, nitrate, and arsenate uptake by the ACE fell behind those of the anion exchange resin in the single-anion solutions, FIG. 9A shows uptake from the mixed-anion solution gave superior performance for M043+HCl towards phosphate, arsenate, and chromate. Despite the seemingly higher anion capacity for the resin, 1.6 mmol anion/g, than the ACE, 1.2 mmol, the amount of negative charge removed by each was nearly equal for the two sorbents, 2.5-2.6 mmol charge/g, as shown in FIG. 9B. This shows the novel ACE demonstrated overall equal uptake performance as the state-of-the-art resin from this highly concentrated mixed system.

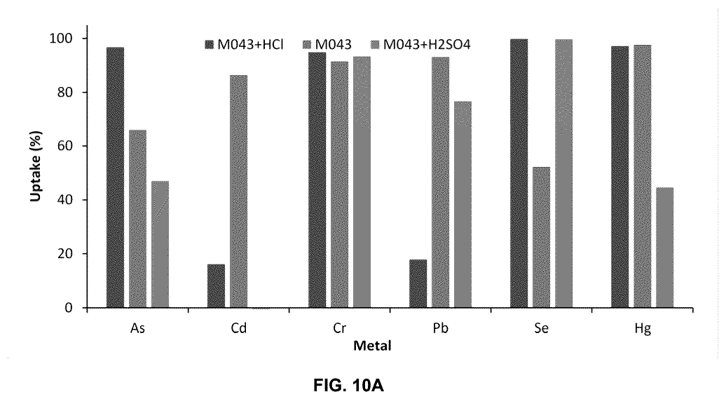

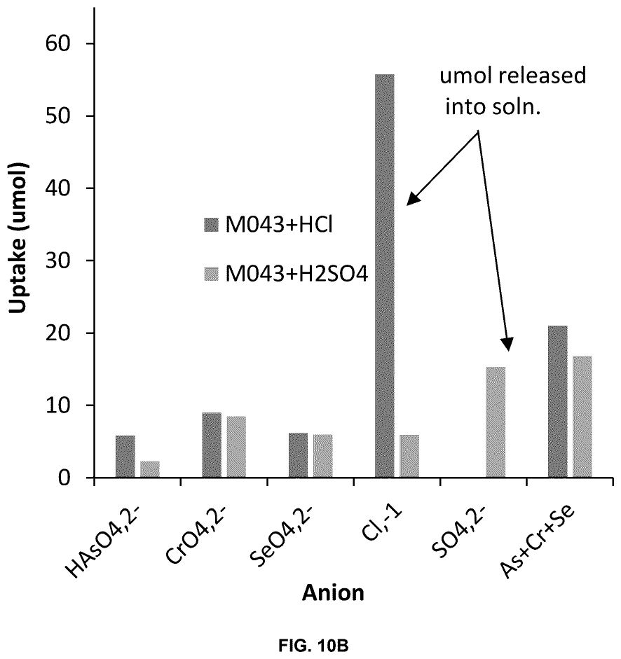

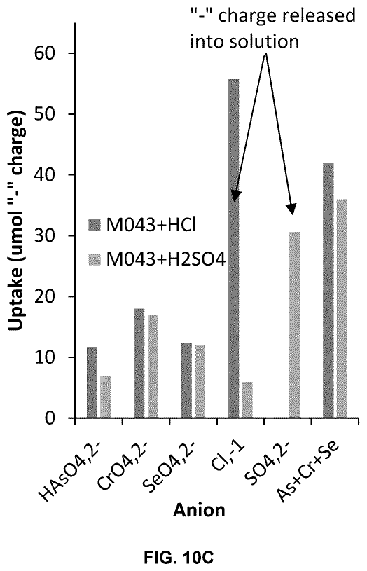

FIG. 10A compares the performance of M043+HCl and M043+H₂SO₄ sorbents to their non-acid-washed M043 counterpart for anion uptake from the less concentrated D6 solution, containing 20 ppm each of three cations and three anions.

Results showed superior performance of the M043+HCl to remove oxyanionic Se (selenate) and As (arsenate), as well as Cr (chromate), than cationic Pb, Cd, and Hg (possible zero charge). The accompanying significant reduction in Pb and Cd for the M043+HCl compared to the chelation-based M043 strongly indicate the anion exchange nature of the ACE. Converting the % uptake of the ions into μmol (FIG. 10B) and charge units (FIG. 10C) removed from/released into solution points towards the anion exchange behavior of the sorbent. About 47.9 μmol of negative charge were removed from the sorbent as selenate, arsenate, and chromate by M043+HCl as 55.8 μmol of negative charge were released by the sorbent into solution as chloride. M043+H₂SO₄ recovered 36 μmol of negative charge from the oxyanionic metals and released about 30.7 μmol of negative charge as a combination of HSO₄⁻ and SO₄²⁻. Note that the ICP-MS could only provide information for sulfate, and so likely counted HSO₄⁻ as SO₄²⁻. These results strongly indicate that ion exchange between Cl⁻ coordinated to the sorbent NH₃⁺/NH₂⁺/NH⁺ groups and oxyanion contaminants in solution is the mechanism of metal capture.

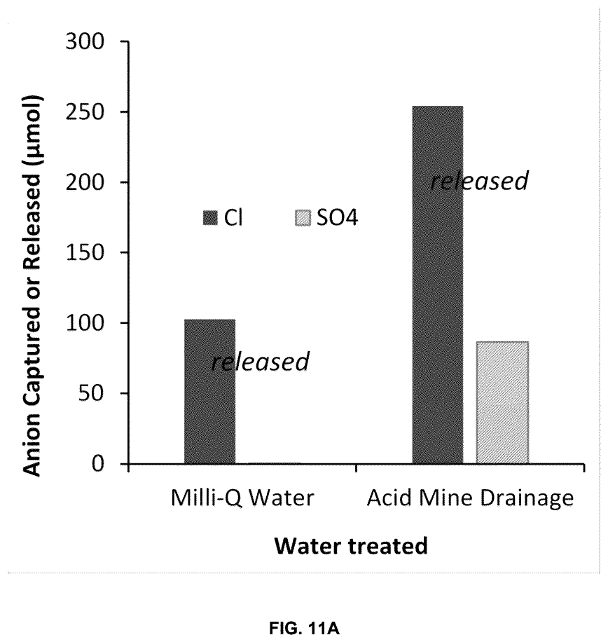

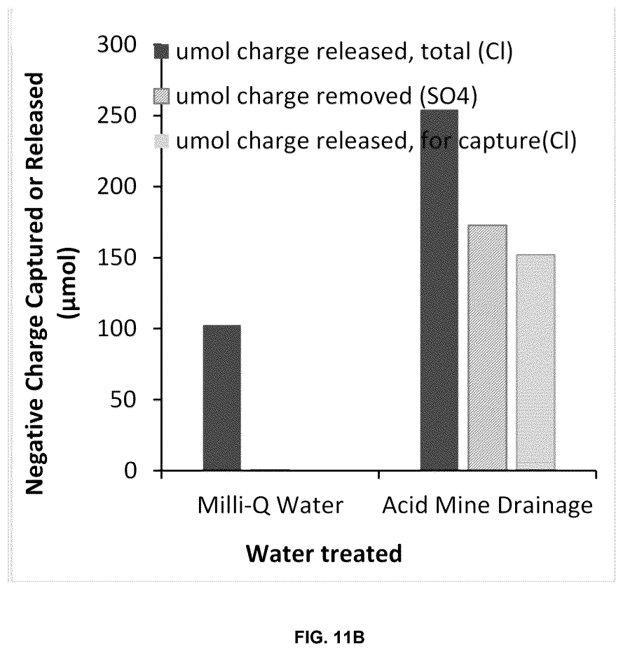

Beyond treating ideal solutions, ACE are well-suited to treat authentic wastewaters of varying compositions. FIG. 11A and FIG. 11B show the results for sulfate removal from authentic acid mine drainage. FIG. 11A shows only CI-release into Milli-Q water while no anions are removed, likely from trace unreacted HCl leaking from the sorbent. Much greater release of Cl⁻ was observed upon removal of SO₄²⁻ from the AMD.

FIG. 11B shows the release and removal of species on a negative charge basis. Correcting the total amount of negative charge released as Cl⁻ (green) due to leakage gives the amount released, 152 μmol (blue), which is close to the amount of negative charge removed as SO₄²⁻, 172.8 (purple). These results confirm that this new set of sorbents behaves as an anion exchanger.

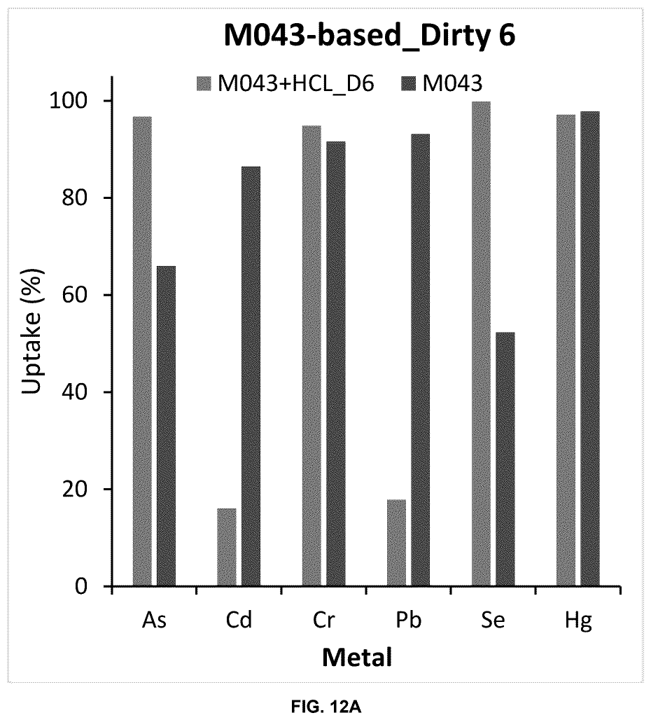

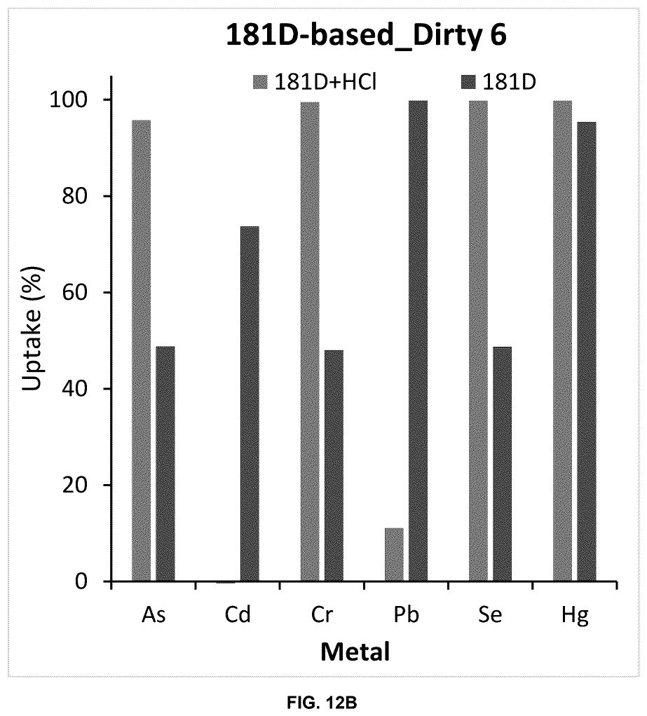

FIG. 12A and FIG. 12B show the versatility of acid-treating different sorbent formulations, specifically 181D, to form the 181D+HCl Ammonium-Coordinated Exchanger. Similar to M043+HCl, 181D+HCl demonstrated superior uptake of arsenate, chromate, and selenate from the D6 solution compared to the 181D chelation-based counterpart.

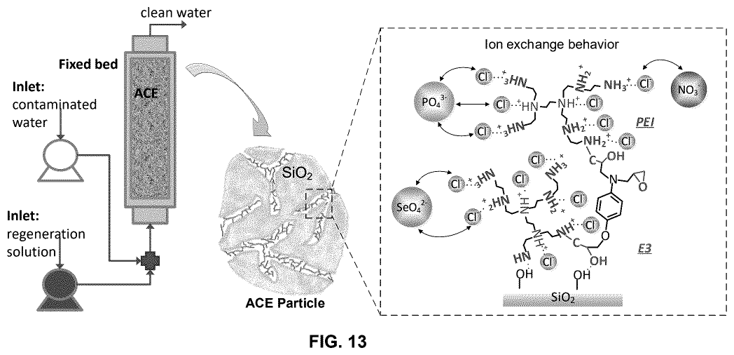

FIG. 13 shows an example of a practical set-up used to remove anions from authentic wastewater flowing from bottom to top, and further illustrates the hypothetical ion exchange mechanism governing the sorbent behavior. Equal charge exchange between ammonium-coordinated chloride anions and aqueous contaminant anions maintains the charge balance of the sorbent. Shown is the displacement of one, two, and three chloride species by mono-, di-, and tri-valent anions, respectively.

Selective Removal of Oxyanions from FGD Wastewater

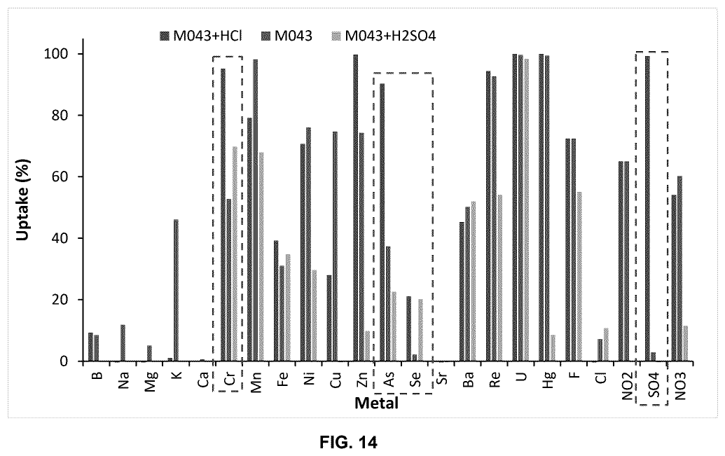

Expanding beyond acid mine drainage, ACE are well-suited to treat authentic flue gas desulfurization (FGD) wastewaters with varying compositions across multiple coal-fired power plant sites. FIG. 14 compares the removal of cationic and anionic contaminant species from FGD, using M043+HCl, M043+HCl, and M043. Obvious is the significantly improved performance of both ACE to remove Cr and Se. Moreover, M043+HCl demonstrated superior performance for not only Cr (chromate) and Se (selenate), but also for As (arsenate) and SO₄₂-(sulfate). Although not regulated by the EPA, removal of sulfate from fossil-related process waters could alleviate problems arising from sulfate scaling—ex. build-up of barium sulfate, calcium sulfate, etc. in piping during oil and gas production.

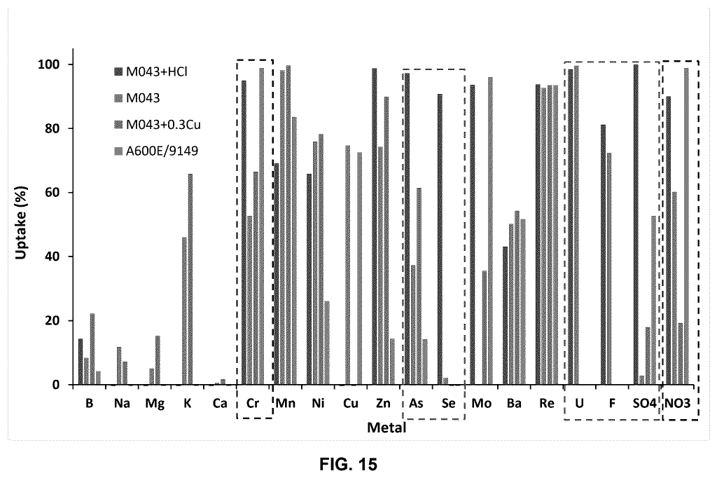

Increasing the amount of sorbent from 0.5 g to 1.0 g to treat 20 mL of the FGD, shown in FIG. 15, improved the overall uptake performance of M043+HCl, especially for Se (21% to 91%) and nitrate (54% to 90%). Moreover, comparing the performance of M043+HCl with previous generation BIAS and metal-loaded BIAS materials plus a specially designed commercial anion exchange resin, A600E/9149, highlighted the superior performance of novel ACE material. M043+HCl demonstrated superior performance over previous BIAS towards Cr, As, Se, SO₄²⁻, and NO₃⁻. More impressively, the sorbent performed dramatically better than A600E/9149 towards As, Se, and SO₄²⁻ while falling only slightly below for Cr and NO₃⁻. These results prove that the novel ACE can have key performance advantages over state-of-the art commercial materials. Note that 1.0 g M043+HCl outperformed 1.0 g M043 towards nitrate removal, compared to the opposite trend when using 0.5 g sorbent.

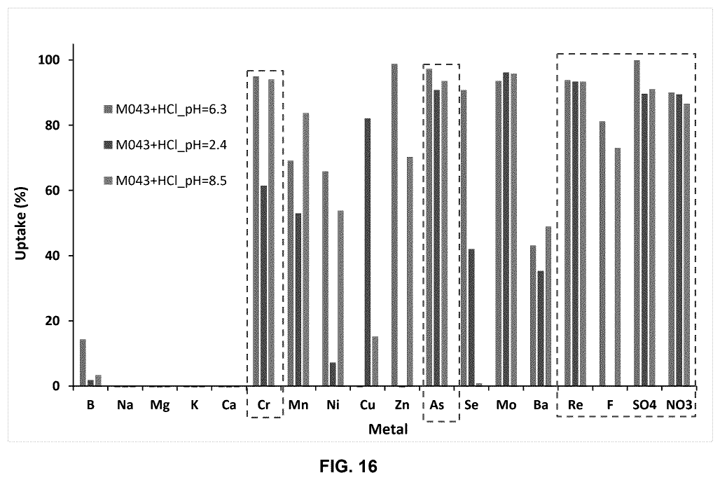

FIG. 16 shows that changing the pH of Aquatech FGD negligibly affected the uptake of HAsO₄²⁻ (arsenate), NO₃⁻, SO₄²⁻, Re (Perrhenate, ReO₄⁻), and F (stock F⁻¹ below detection limit at pH 2.4), yet reduced the uptake of Cr (chromate), which may have resulted from transforming CrO₄²⁻ into HCrO₄⁻. Se uptake was affected the most, being reduced to near 0% at high pH. This shows that for most anions tested, the ACS was effective between pH 2.4 and 8.5.

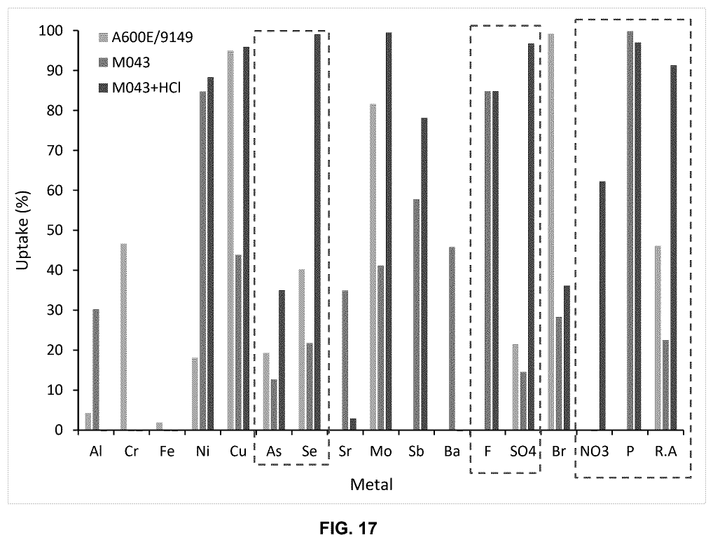

FIG. 17 shows another comparison between the wet M043+HCl and A600E/9149 (inherently wet) sorbent for fixed-bed removal of contaminants from aged Longview Power Plant FGD (Maidsvillew, WV) spiked with selenate and treated by NaS. The NaS treatment represents a viable route towards eliminating contaminants prior to an adsorption bed to improve metal uptake. M043+HCl (wet) removed appreciably more arsenate, selenate, fluoride, sulfate, and nitrate than A600E/9149, which did adsorbed more chromate and bromide. Collectively, M043+HCl recovered 91% of regulated anions (R.A.) listed by the EPA for tap water (R.A.—chromate, arsenate, selenate, fluoride, and nitrate) plus bromide, which is oxidized by ozone to form bromate (EPA regulated for tap water). The resin adsorbed only about half as much of these species (42%) as the 043+HCl. Phosphate, originating from the buffer used in the aged, NaS-treated LV solution, was determined by ICP-MS. Uptake of this species (reported as phosphorous, P) was ˜97% for M043+HCl, which dwarfed the 0.19% uptake by the anion exchange resin. This further highlights the excellent performance of the novel ACE in cleaning some real-world contaminated waters.

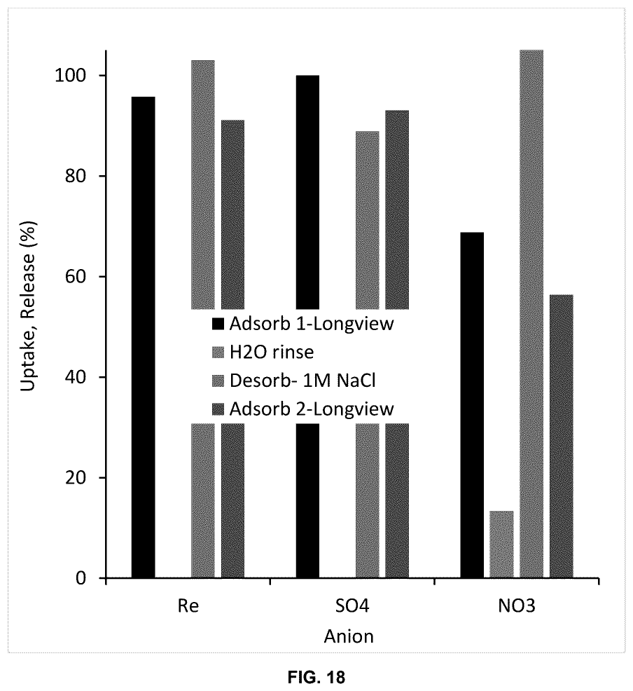

Testing the regenerability of the ACE, 20 mL of authentic flue gas desulfurization wastewater from the coal-fired Longview Coal Power Plant were treated with 1.5 g M043+HCl, using the flow column. Subsequently, the M043+HCL ACE was rinsed with 20 mL water to remove interstitial FGD; regenerated by flowing 20 mL 1.M NaCl solution; rinsed again; then used to treat an additional 20 mL FGD. FIG. 18 presents the cycle testing data, where black bars show anion uptake of Rh (rhenate), sulfate, and nitrate for the first cycle; blue bars show the percentage of adsorbed species that were removed from the sorbent by a simple water wash; green bars show the percentage of adsorbed species desorbed by flowing concentrated NaCl/H₂O; and red bars show anion uptake by the ACE during the second treatment. Nearly none of the adsorbed species were removed by H₂O caused by strong binding to the sorbent, whereas all species were removed by introducing concentrated NaCl. During desorption, the Cl⁻¹ displaced the adsorbed anionic species, which also regenerated the active exchange sites to adsorbed metals again. Only slight loss in the uptake of the anions was observed after the first uptake. This loss could be remedied by refining the desorption process.

### Inorganic Contaminant (Dye) Uptake and pH Adjustment

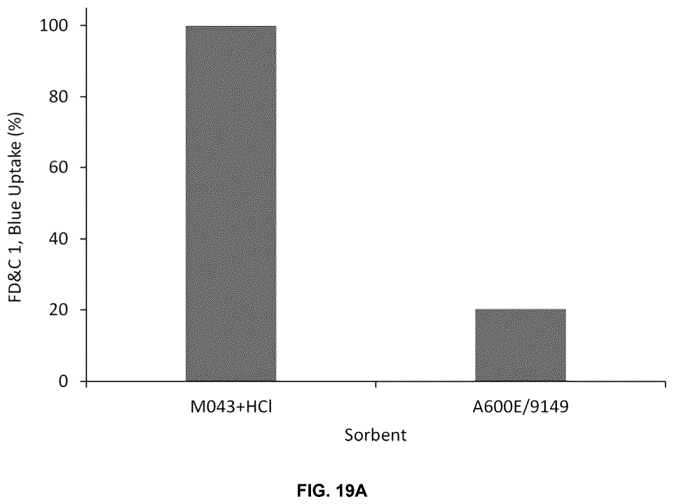

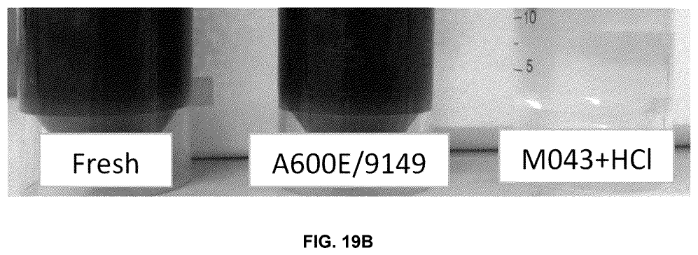

FIG. 19A highlights the versatility of the ACE towards removing anion FD&C blue 1 dye from a 1 wt % solution of blue McCormick brand “Neon Food Coloring.” FD&C blue 1 is an FDA-approved food grade dye that contains alkyl, aromatic, and anionic functional groups often found in organic anionic contaminants like benzene sulfonate, and pharmaceuticals like ibuprofen. Compared with the A600E/9149 resin, the wet M043+HCl gave dramatically higher uptake, as visually evident from the extremely dilute color (FIG. 19B). Dry M043+HCl performed similarly as wet M043+HCl for blue dye removal (not shown).

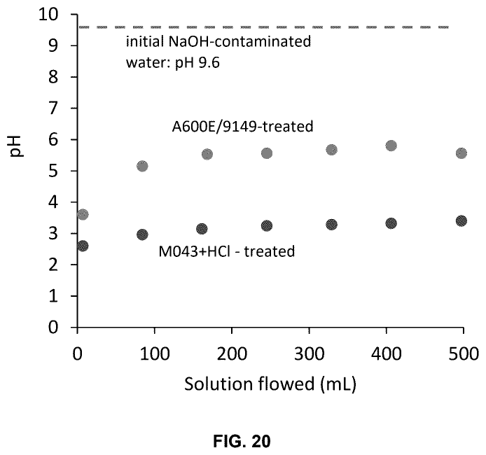

According to the U.S. Environmental Protection Agency, high pH water is classified as above 9 for prolonged time or at high frequency and its effects on biological life can include reduced biodiversity, decreased organism growth and reproduction, and damage to skin and gills plus olfactory organs and eyes. Sources of high pH can include industrial discharge and landfills; oil and gas brines; and cement and soap manufacturing. FIG. 20 shows the results of treating high pH water by flowing 500 mL of pH 9.6 NaOH/H₂O at 0.5 mL/min over 0.5 g M043+HCl and 0.88 g A600E/9149 (0.5 g dry resin) in a fixed bed set up. A series of 7 mL eluent fractions were acquired by an autosampler and tested for their pH with a calibrated pH meter.

Results show that even after passing 1,000 bed masses of high pH water over the sorbent, the pH was maintained below 3.5 for M043+HCl and was mostly above 5.0 for the resin. Although this pH achieved by the ACE here is too low for discharge into environmental water systems, adjusting the flow rate or sorbent mass, i.e. weighted hourly space velocity, will give the desired safe effluent pH. Furthermore, these results show greater pH reduction power for the ACE than a commercial resin. Moreover, M043+HCl can both reduce toxic anionic inorganic organic contaminants and also regulate the pH level of contaminated water systems.

TABLE 5 compares the key performance and cost metrics of the M043+HCl and A600E/9149 resin. The total M043+HCl sorbent cost was estimated from (i) vendor raw material costs at 2,000 lb purchase quantities; (ii) manufacturing costs for a sorbent prepared by functionalizing pretreated clay (silica-alumina) with an acrylamide-methylenebisacrylamide polymer, then acid washing; and (iii) assuming a profit margin of 25%. M043+HCl displays nearly identical relative maximum charge uptake capacity as the resin, yet greatly better performance at pH reduction and removal of regulated anions from authentic FGD. Moreover, the estimated cost for the M043+HCl ACE is 56% lower than that of the resin. This assessment further highlights the significance of the novel ACE towards anionic contaminant removal.

TABLE 5
Performance comparison between NETL ammonium-
coordinated anion exchanger (ACE) and commercial
A600E/9149 anion exchange resin.

| | Relative Maximum | | | | |
|---|---|---|---|---|---|
| | Capacity (mixed | | | | |
| | anions) | | pH | FGD R.A. | |
| | wt % | mmol | Reduction^{a} | Removal^{b} | Price |
| Sorbent | anions | charge/g | pH units | % | $/kg |
| M043 + HCl | 7.4 | 2.5 | 6.2 | 91 | 7^{c} |
| A600E/9149 | 8 | 2.6 | 4.1 | 46 | 16.4^{d} |

^{a}Difference between initial pH of 9.6 and final pH after flowing 500 mL (~500X sorbent mass);
^{b}R.A. totals chromate, arsenate, selenate, fluoride, nitrate, and bromide from NaS treated, SeO₄²⁻ spiked Longview FGD;
^{c}reagent costs obtained according to 2,000 lbs quantities;
^{d}price converted from $/cuft in 2016 (37 ton quantity) [11] to $/kg in 2021 using producer price indices for Chemicals and Allied Products - water treating compounds (commodity code 0679-0961) and resin bulk density of 0.69 g/cm³ determined in the lab.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. An ammonium-coordinated exchanger, comprising:
a polyamine network covalently attached to a substrate by a cross-linker, wherein said polyamine comprises amine groups; and
an exchangeable anion coordinated to at least some of said amine groups.

2. The ammonium-coordinated exchanger of claim 1 wherein the polyamine is selected from the group consisting of: polyethylenimine, ethylenediamine, diethylenetriamine, triethylenetetramine, tetraethylenepentamine, pentaethylenehexamine, hexaethyleneheptamine, 1,3-cyclohexanebis(methylamine), 4,4′-Methylenebis(cyclohexylamine), 3,3′-Methylenedianiline, 4,4′-Methylenedianiline, o-phenylenediamine, m-phenylenediamine, p-phenylenediamine, Tris(2-aminoethyl)amine, p-Xylylenediamine, 4-Chloro-o-phenylenediamine, N,N′-Dimethyl-1,3-propanediamine, N,N′-Diphenyl-p-phenylenediamine, N,N′-Diisopropyl-1,3-propanediamine, polyvinyl amine, poly(allylamine), poly(propyleneimine), and combinations thereof.

3. The ammonium-coordinated exchanger of claim 1 wherein the cross-linker is selected from the group consisting of: tri-epoxide monomer, N—N-diglycidyl-4-glycidyloxyaniline (E3), epoxysilane, 2-(3,4-epoxycyclohexyl)ethyltrimethoxysilane (ECETMS), aminosilanes, 3-aminopropyltrimethoxysilane (APTMS), 3-aminopropyltriethoxysilane, N-(3-trimethoxysilyl)propyl)ethylenediamine (TMPED), N-(3-Trimethoxysilylpropyl) diethylenetriamine (TMPDET), chlorosilane, 3-chloropropyltriethoxysilane, 3-chloropropyltrimethoxysilane, and combinations thereof.

4. The ammonium-coordinated exchanger of claim 1 wherein the substrate is selected from the group consisting of: silica, bio-char, natural and synthetic zeolites, fly ash, alumina, activated carbon, metal surfaces comprising pendant —OH groups, porous polymers comprising pendant —OH groups, and combinations thereof.

5. The ammonium-coordinated exchanger of claim 1 wherein the exchangeable anion is selected from the group consisting of: chloride, hydroxide, sulfate, hydrogen sulfate, nitrate, carbonate, and bicarbonate, and combinations thereof.

6. A method of making an ammonium-coordinated exchanger, comprising:
generating a basic immobilized amine sorbent; and
exposing the sorbent to an acid to form an ammonium-coordinated exchanger.

7. The method of claim 6 wherein the acid is selected from the group consisting of: hydrochloric acid, acetic acid, sulfuric acid, sulfuric acid, nitric acid, carbonic acid, and combinations thereof.

8. A method of making an ammonium-coordinated exchanger, comprising:
forming an impregnation solution comprising a polyamine, cross-linkers, and anion exchange linkers, wherein said polyamine comprises amine groups; and
combining the impregnation solution with a substrate to form an ammonium-coordinated exchanger, wherein said ammonium coordinated exchanger comprises an exchangeable anion coordinated to at least some of said amine groups.

9. The method of claim 8 wherein the amount of different polyamines and cross-linkers is selected based on at least an amount of anionic species to be captured.

10. The method of claim 8 wherein the polyamine is selected from the group consisting of: polyethylenimine, ethylenediamine, diethylenetriamine, triethylenetetramine, tetraethylenepentamine, pentaethylenehexamine, hexaethyleneheptamine, 1,3-cyclohexanebis(methylamine), 4,4′-Methylenebis(cyclohexylamine), 3,3′-Methylenedianiline, 4,4′-Methylenedianiline, o-phenylenediamine, m-phenylenediamine, p-phenylenediamine, Tris(2-aminoethyl)amine, p-Xylylenediamine, 4-Chloro-o-phenylenediamine, N,N′-Dimethyl-1,3-propanediamine, N,N′-Diphenyl-p-phenylenediamine, N,N′-Diisopropyl-1,3-propanediamine, polyvinyl amine, poly(allylamine), poly(propyleneimine), and combinations thereof.

11. The method of claim 8 wherein the cross-linker is selected from the group consisting of: tri-epoxide monomer, N—N-diglycidyl-4-15 glycidyloxyaniline (E3), epoxysilane, 2-(3,4-epoxycyclohexyl)ethyltrimethoxysilane (ECETMS), aminosilanes, 3-aminopropyltrimethoxysilane (APTMS), 3-aminopropyltriethoxysilane, N-(3-trimethoxysilyl)propyl)ethylenediamine (TMPED), N-(3-Trimethoxysilylpropyl) diethylenetriamine (TMPDET), chlorosilane, 3-chloropropyltriethoxysilane, 3-chloropropyltrimethoxysilane, and combinations thereof.

12. The method of claim 8 wherein the anion exchange linker is selected from the group consisting of: α,α-dichloro-p-xylene (DPX), carmustine, α,α-dichloro-m-xylene, 1,3-dichloropropanol, 1,3-dichlorobutane, 1,3-dichlorobenzene, 1,4-dichlorobenzene, and combinations thereof.

13. The method of claim 8 wherein the substrate is selected from the group consisting of: silica, bio-char, natural and synthetic zeolites, fly ash, alumina, activated carbon, metal surfaces comprising pendant —OH groups, porous polymers comprising pendant —OH groups, and combinations thereof.

14. The method of claim 8 wherein the exchangeable anion is selected from the group consisting of chloride, hydroxide, sulfate, hydrogen sulfate, nitrate, carbonate, and bicarbonate, and combinations thereof.

15. A method of using an ammonium-coordinated exchanger to capture an anionic species from a liquid source comprising:
exposing the ammonium-coordinated exchanger to the liquid source, wherein the ammonium-coordinated exchanger comprises:
a polyamine network covalently attached to a substrate by a cross-linker, wherein said polyamine comprises amine groups; and
an exchangeable anion coordinated to at least some of said amine groups; and
capturing at least some amount of the anionic species from the liquid source.

16. The method of claim 15 wherein the polyamine is selected from the group consisting of: polyethylenimine, ethylenediamine, diethylenetriamine, triethylenetetramine, tetraethylenepentamine, pentaethylenehexamine, hexaethyleneheptamine, 1,3-cyclohexanebis(methylamine), 4,4′-Methylenebis(cyclohexylamine), 3,3′-Methylenedianiline, 4,4′-Methylenedianiline, o-phenylenediamine, m-phenylenediamine, p-phenylenediamine, Tris(2-aminoethyl)amine, p-Xylylenediamine, 4-Chloro-o-phenylenediamine, N,N′-Dimethyl-1,3-propanediamine, N,N′-Diphenyl-p-phenylenediamine, N,N′-Diisopropyl-1,3-propanediamine, polyvinyl amine, poly(allylamine), poly(propyleneimine), and combinations thereof.

17. The method of claim 15 wherein the cross-linker is selected from the group consisting of: tri-epoxide monomer, N—N-diglycidyl-4-15 glycidyloxyaniline (E3), epoxysilane, 2-(3,4-epoxycyclohexyl)ethyltrimethoxysilane (ECETMS), aminosilanes, 3-aminopropyltrimethoxysilane (APTMS), 3-aminopropyltriethoxysilane, N-(3-trimethoxysilyl)propyl)ethylenediamine (TMPED), N-(3-Trimethoxysilylpropyl) diethylenetriamine (TMPDET), chlorosilane, 3-chloropropyltriethoxysilane, 3-chloropropyltrimethoxysilane.

18. The method of claim 15 wherein the substrate is selected from the group consisting of: silica, bio-char, natural and synthetic zeolites, fly ash, alumina, activated carbon, metal surfaces comprising pendant —OH groups, porous polymers comprising pendant —OH groups, and combinations thereof.

19. The ammonium-coordinated exchanger of claim 15 wherein the exchangeable anion is selected from the group consisting of: chloride, hydroxide, sulfate, hydrogen sulfate, nitrate, carbonate, and bicarbonate, and combinations thereof.

20. The method of claim 15 further comprising anion exchange sites within the substrate.

21. The method of claim 15 further comprising releasing adsorbed anionic species and regenerating the ammonium-coordinated exchanger.

22. The method of claim 15 wherein at least one anionic species is selected from the group consisting of oxyanoinic, anionic metal, anionic metalloid, isotopic radioactive, anionic organic species, and combinations thereof.
